(19) United States
(12) Patent Application Publication
(10) Pub. No.: US 2015/0363219 A1
(43) Pub. Date: Dec. 17, 2015

(54) OPTIMIZATION TO CREATE A HIGHLY SCALABLE VIRTUAL NETORK SERVICE/APPLICATION USING COMMODITY HARDWARE

(71) Applicant: Avni Networks Inc., Milpitas, CA (US)

(72) Inventors: Rohini Kumar Kasturi, Sunnyvale, CA (US); Bharanidharan Seetharaman, Sunnyvale, CA (US); Bhaskar Bhupalam, Fremont, CA (US); Vibhu Pratap, Santa Clara, CA (US); Bojjiraju Satya Nanduri, Fremont, CA (US); Tushar Rajnikant Jagtap, Sunnyvale, CA (US)

(21) Appl. No.: 14/712,876

(22) Filed: May 14, 2015

Related U.S. Application Data
(63) Continuation-in-part of application No. 14/702,649, filed on May 1, 2015.
Application No. 14/702,649 is a continuation-in-part of application No. 14/681,057, filed on Apr. 7, 2015.
Application No. 14/681,057 is a continuation-in-part of application No. 14/214,682, filed on Mar. 15, 2014.
Application No. 14/214,682 is a continuation-in-part of application No. 14/214,666, filed on Mar. 15, 2014.
Application No. 14/214,666 is a continuation-in-part of application No. 14/214,612, filed on Mar. 14, 2014.
Application No. 14/214,612 is a continuation-in-part of application No. 14/214,572, filed on Mar. 14, 2014.
Application No. 14/214,572 is a continuation-in-part of application No. 14/214,472, filed on Mar. 14, 2014.
Application No. 14/214,472 is a continuation-in-part of application No. 14/214,326, filed on Mar. 14, 2014.
(60) Provisional application No. 61/994,098, filed on May 15, 2014.

(51) Int. Cl. G06F 9/455

(52) U.S. Cl. CPC G06F 9/45558; G06F 2009/45595; G06F 2009/4557

(57) ABSTRACT

A method of deployment of virtual machines (VMs) including receiving traffic having characteristics from clients and based on the traffic, dynamically bringing up son VMs and when the traffic goes down, removing the son VMs. Sharing a cache between the son VMs by the VMs directly accessing the cache when receiving traffic from existing clients and performing encryption/decryption for new clients.

### CROSS-REFERENCE TO RELATED APPLICATIONS

This application claims priority to U.S. Provisional Patent Application No. 61/994,098, filed on May 15, 2014, by Rohini Kumar Kasturi, et al., and entitled “OPTIMIZATION TO CREATE A HIGHLY SCALABLE VIRTUAL NETORK SERVICE/APPLICATION USING COMMODITY HARDWARE” and is a continuation-in-part of U.S. patent application Ser. No. 14/702,649, filed on May 1, 2015, by Rohini Kumar Kasturi, et al., and entitled “METHOD AND APPARATUS FOR APPLICATION AND L4-L7 PROTOCOL AWARE DYNAMIC NETWORK ACCESS CONTROL, THREAT MANAGEMENT AND OPTIMIZATIONS IN SDN BASED NETWORKS”, and is a continuation-in-part of U.S. patent application Ser. No. 14/681,057, filed on Apr. 7, 2015, by Rohini Kumar Kasturi, et al., and entitled “SMART NETWORK AND SERVICE ELEMENTS”, which is a continuation-in-part of U.S. patent application Ser. No. 14/214,682, filed on Mar. 17, 2014, by Kasturi et al. and entitled “METHOD AND APPARATUS FOR CLOUD BURSTING AND CLOUD BALANCING OF INSTANCES ACROSS CLOUDS”, which is a continuation-in-part of U.S. patent application Ser. No. 14/214,666, filed on Mar. 17, 2014, by Kasturi et al., and entitled “METHOD AND APPARATUS FOR AUTOMATIC ENABLEMENT OF NETWORK SERVICES FOR ENTERPRISES”, which is a continuation-in-part of U.S. patent application Ser. No. 14/214,612, filed on Mar. 14, 2014, by Kasturi et al., and entitled “METHOD AND APPARATUS FOR RAPID INSTANCE DEPLOYMENT ON A CLOUD USING A MULTI-CLOUD CONTROLLER”, which is a continuation-in-part of U.S. patent application Ser. No. 14/214,572, filed on Mar. 14, 2014, by Kasturi et al., and entitled “METHOD AND APPARATUS FOR ENSURING APPLICATION AND NETWORK SERVICE PERFORMANCE IN AN AUTOMATED MANNER”, which is a continuation-in-part of U.S. patent application Ser. No. 14/214,472, filed on Mar. 14, 2014, by Kasturi et al., and entitled, “PROCESSES FOR A HIGHLY SCALABLE, DISTRIBUTED, MULTI-CLOUD SERVICE DEPLYMENT, ORCHESTRATION AND DELIVERY FABRIC”, which is a continuation-in-part of U.S. patent application Ser. No. 14/214,326, filed on Mar. 14, 2014, by Kasturi et al., and entitled, “METHOD AND APPARATUS FOR HIGHLY SCALABLE, MULTI-CLOUD SERVICE DEVELOPMENT, ORCHESTRATION AND DELIVERY”, which are incorporated herein by reference as though set forth in full.

### Field of the Invention

Various embodiments and methods of the invention relate generally to a multi-cloud data center and particularly to real-time re-direction of traffic flow in the presence of attack traffic.

### BACKGROUND

Data centers refer to facilities used to house computer systems and associated components, such as telecommunications (networking equipment) and storage systems. They generally include redundancy, such as redundant data communications connections and power supplies. These computer systems and associated components generally make up the Internet. A metaphor for the Internet is cloud.

A large number of computers connected through a real-time communication network such as the Internet generally form a cloud. Cloud computing refers to distributed computing over a network, and the ability to run a program or application on many connected computers of one or more clouds at the same time.

The cloud has become one of the, or perhaps even the, most desirable platform for storage and networking. A data center with one or more clouds may have server, switch, storage systems, and other networking and storage hardware, but actually served up by virtual hardware, simulated by software running on one or more networking machines and storage systems. Therefore, virtual servers, storage systems, switches and other networking equipment are employed. Such virtual equipment do not physically exist and can therefore be moved around and scaled up or down on the fly without any difference to the end user, somewhat like a cloud becoming larger or smaller without being a physical object. Cloud bursting refers to a cloud, including networking equipment, becoming larger or smaller.

Clouds also focus on maximizing the effectiveness of shared resources, resources referring to machines or hardware such as storage systems and/or networking equipment. Sometimes, these resources are referred to as instances. Cloud resources are usually not only shared by multiple users but are also dynamically reallocated per demand. This can work for allocating resources to users. For example, a cloud computer facility, or a data center, that serves Australian users during Australian business hours with a specific application (e.g., email) may reallocate the same resources to serve North American users during North America's business hours with a different application (e.g., a web server). With cloud computing, multiple users can access a single server to retrieve and update their data without purchasing licenses for different applications.

Cloud computing allows companies to avoid upfront infrastructure costs, and focus on projects that differentiate their businesses, not their infrastructure. It further allows enterprises to get their applications up and running faster, with improved manageability and less maintenance, and that enable information technology (IT) to more rapidly adjust resources to meet fluctuating and unpredictable business demands.

Fabric computing or unified computing involves the creation of a computing fabric system consisting of interconnected nodes that look like a ‘weave’ or a ‘fabric’ when viewed collectively from a distance. Usually this refers to a consolidated high-performance computing system consisting of loosely coupled storage, networking and parallel processing functions linked by high bandwidth interconnects.

The fundamental components of fabrics are “nodes” (processor(s), memory, and/or peripherals) and “links” (functional connection between nodes). Manufacturers of fabrics (or fabric systems) include companies, such as IBM and Brocade. These companies are examples of fabrics made of hardware. Fabrics are also made of software or a combination of hardware and software.

SSL uses encryption/decryption as its security measure but the encryption and decryption of data for traffic (or “communication”) leads to overhead for the servers. This issue is typically addressed by adding a dedicated and specialized hardware, or a commodity x86 processor to perform the encryption/decryption fast enough not to hold up the server. However, this approach is undesirably resource-intensive and costly.

A data center employed with a cloud currently lacks optimization and automation therefore being inefficient and static.

### SUMMARY

Briefly, a method of deployment of virtual machines (VMs) including receiving traffic having characteristics from clients and based on the traffic, dynamically bringing up son VMs and when the traffic goes down, removing the son VMs. Sharing a cache between the son VMs by the VMs directly accessing the cache when receiving traffic from existing clients and performing encryption/decryption for new clients. Today's web traffic is inherently insecure and prone to attacks, largely through interception of the traffic between browsers and servers. To circumvent this problem, websites now offer “https” support where communication between a subscriber (or “user”) and servers takes place over a secure socket layer tunnel (SSL), i.e. a secure tunnel, between the browser and the server.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a data center 100, in accordance with an embodiment of the invention.

FIG. 2 shows details of relevant portions of the data center 100 and in particular, the fabric system 106 of FIG. 1.

FIG. 3 shows, conceptually, various features of the data center 300, in accordance with an embodiment of the invention.

FIG. 4 shows, in conceptual form, relevant portions of a multi-cloud data center 400, in accordance with another embodiment of the invention.

FIGS. 4a-c show exemplary data centers configured using various embodiments and methods of the invention.

FIG. 5 shows a system 500 for generating UI screenshots, in a networking system, defining tiers and profiles.

FIG. 6 shows a portion of a multi-cloud fabric system 602 including a controller 604.

FIG. 7 shows a build server, in accordance with an embodiment of the invention.

FIG. 8 shows a networking system using various methods and embodiments of the invention.

FIG. 9 shows a data center 1100 is shown, in accordance with an embodiment of the invention.

FIG. 10 shows a load balancing system 1200, in accordance with another method and embodiment of the invention.

FIGS. 11-12 shows data packet flow paths that dynamically change, through the data center 1100, in accordance with various methods and embodiments of the invention.

FIG. 13 shows an exemplary data center 1500, in accordance with various methods and embodiments of the invention.

FIG. 14 shows in conceptual form, relevant portions of a multi-cloud data center 1200 with real-time cloud security, in accordance with an embodiment of the invention.

FIG. 15 shows a flow diagram of the real-time cloud security in a multi-cloud data center 1230, in accordance with an embodiment of the invention.

FIG. 16 shows flow charts of the relevant steps 1250 performed by the multi-cloud data center 1200, in accordance with various methods of the invention.

FIG. 17 shows a deployment system 1600 is shown, in accordance with an embodiment of the invention.

FIG. 18 shows a flow chart of some of the steps performed by the SSL farm of FIG. 17, in accordance with an exemplary method of the invention.

### DETAILED DESCRIPTION OF EMBODIMENTS

The following description describes methods and apparatus for deployment of multi-tiered virtual machine (VM) for a typical web (Internet) application. Deployment of VMs is in the context of multi-cloud environments and performed substantially in real-time, dynamically, and virtually seamlessly, as discussed below.

In various embodiments and apparatus of the invention, deployment of VMs is controllably done enabling a system utilizing, for example a multi-cloud fabric, to automatically, dynamically, and substantially seamlessly insert (or “deploy” or “launch”) a customized node to perform SSL for a web application and therefore offload the servers.

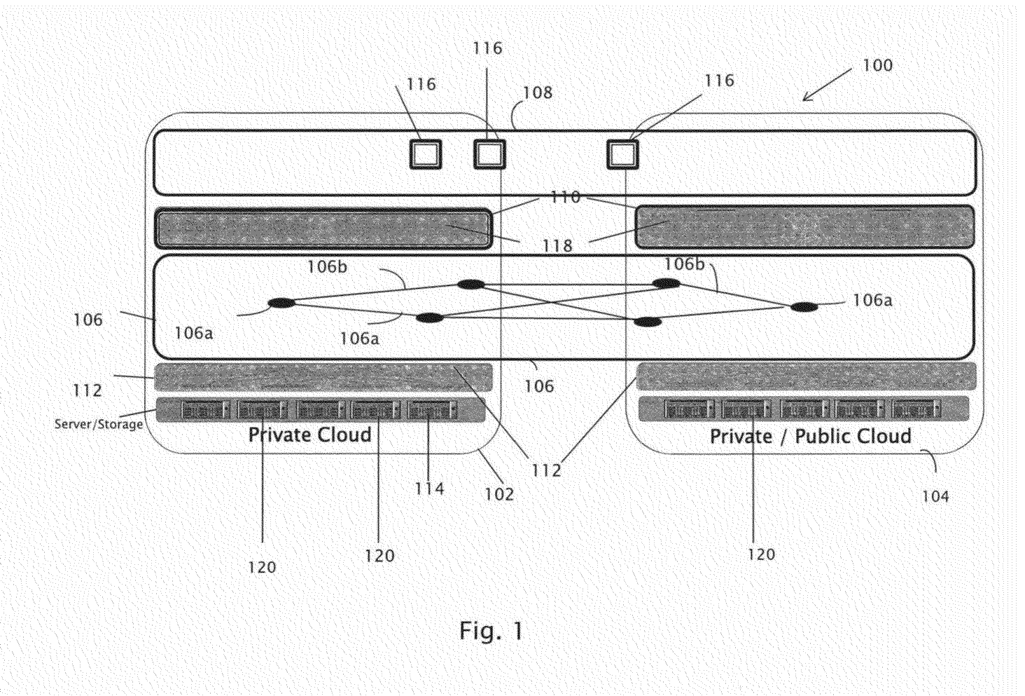

Referring now to FIG. 1, a data center 100 is shown, in accordance with an embodiment of the invention. The data center 100 is shown to include a private cloud 102 and a hybrid cloud 104. A hybrid cloud is a combination public and private cloud. The data center 100 is further shown to include a plug-in unit 108 and a multi-cloud fabric system 106 spanning across the clouds 102 and 104. Each of the clouds 102 and 104 are shown to include a respective application layer 110, a network 112, and resources 114.

The network 112 includes switches, router, and the like and the resources 114 includes networking and storage equipment, i.e. machines, such as without limitation, servers, storage systems, switches, servers, routers, or any combination thereof.

The application layers 110 are each shown to include applications 118, which may be similar or entirely different or a combination thereof.

The plug-in unit 108 is shown to include various plug-ins (orchestration). As an example, in the embodiment of FIG. 1, the plug-in unit 108 is shown to include several distinct plug-ins 116, such as one made by Opensource, another made by Microsoft, Inc., and yet another made by VMware, Inc. The foregoing plug-ins typically each use different formats. The plug-in unit 108 converts all of the various formats of the applications (plug-ins) into one or more native-format applications for use by the multi-cloud fabric system 106. The native-format application(s) is passed through the application layer 110 to the multi-cloud fabric system 106.

The multi-cloud fabric system 106 is shown to include various nodes 106a and links 106b connected together in a weave-like fashion. Nodes 106a are network, storage, or telecommunication or communications devices such as, without limitation, computers, hubs, bridges, routers, mobile units, or switches attached to computers or telecommunications network, or a point in the network topology of the multi-cloud fabric system 106 where lines intersect or terminate. Links 106b are typically data links.

In some embodiments of the invention, the plug-in unit 108 and the multi-cloud fabric system 106 do not span across clouds and the data center 100 includes a single cloud. In embodiments with the plug-in unit 108 and multi-cloud fabric system 106 spanning across clouds, such as that of FIG. 1, resources of the two clouds 102 and 104 are treated as resources of a single unit. For example, an application may be distributed across the resources of both clouds 102 and 104 homogeneously thereby making the clouds seamless. This allows use of analytics, searches, monitoring, reporting, displaying and otherwise data crunching thereby optimizing services and use of resources of clouds 102 and 104 collectively.

While two clouds are shown in the embodiment of FIG. 1, it is understood that any number of clouds, including one cloud, may be employed. Furthermore, any combination of private, public and hybrid clouds may be employed. Alternatively, one or more of the same type of cloud may be employed.

In an embodiment of the invention, the multi-cloud fabric system 106 is a Layer (L) 4-7 fabric system. Those skilled in the art appreciate data centers with various layers of networking. As earlier noted, multi-cloud fabric system 106 is made of nodes 106a and connections (or “links”) 106b. In an embodiment of the invention, the nodes 106a are devices, such as but not limited to L4-L7 devices. In some embodiments, the multi-cloud fabric system 106 is implemented in software and in other embodiments, it is made with hardware and in still others, it is made with hardware and software.

Some switches can use up to OSI layer 7 packet information; these may be called layer (L) 4-7 switches, content-switches, content services switches, web-switches or application-switches.

Content switches are typically used for load balancing among groups of servers. Load balancing can be performed on HTTP, HTTPS, VPN, or any TCP/IP traffic using a specific port. Load balancing often involves destination network address translation so that the client of the load balanced service is not fully aware of which server is handling its requests. Content switches can often be used to perform standard operations, such as SSL encryption/decryption to reduce the load on the servers receiving the traffic, or to centralize the management of digital certificates. Layer 7 switching is the base technology of a content delivery network.

The multi-cloud fabric system 106 sends one or more applications to the resources 114 through the networks 112.

In a service level agreement (SLA) engine, as will be discussed relative to a subsequent figure, data is acted upon in real-time. Further, the data center 100 dynamically and automatically delivers applications, virtually or in physical reality, in a single or multi-cloud of either the same or different types of clouds.

The data center 100, in accordance with some embodiments and methods of the invention, functions as a service (Software as a Service (SAAS) model, a software package through existing cloud management platforms, or a physical appliance for high scale requirements. Further, licensing can be throughput or flow-based and can be enabled with network services only, network services with SLA and elasticity engine (as will be further evident below), network service enablement engine, and/or multi-cloud engine.

As will be further discussed below, the data center 100 may be driven by representational state transfer (REST) application programming interface (API).

The data center 100, with the use of the multi-cloud fabric system 106, eliminates the need for an expensive infrastructure, manual and static configuration of resources, limitation of a single cloud, and delays in configuring the resources, among other advantages. Rather than a team of professionals configuring the resources for delivery of applications over months of time, the data center 100 automatically and dynamically does the same, in real-time. Additionally, more features and capabilities are realized with the data center 100 over that of prior art. For example, due to multi-cloud and virtual delivery capabilities, cloud bursting to existing clouds is possible and utilized only when required to save resources and therefore expenses.

Moreover, the data center 100 effectively has a feedback loop in the sense that results from monitoring traffic, performance, usage, time, resource limitations and the like, i.e. the configuration of the resources can be dynamically altered based on the monitored information. A log of information pertaining to configuration, resources, the environment, and the like allow the data center 100 to provide a user with pertinent information to enable the user to adjust and substantially optimize its usage of resources and clouds. Similarly, the data center 100 itself can optimize resources based on the foregoing information.

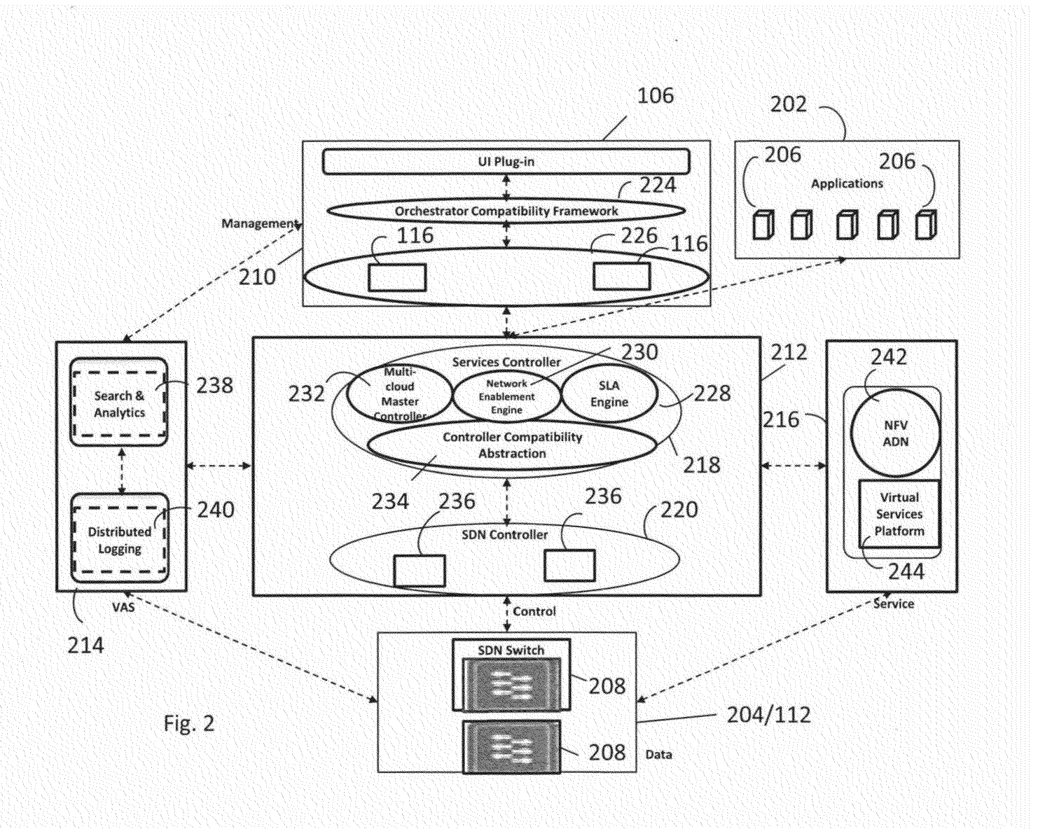

FIG. 2 shows further details of relevant portions of the data center 100 and in particular, the fabric system 106 of FIG. 1. The fabric system 106 is shown to be in communication with a applications unit 202 and a network 204, which is shown to include a number of Software Defined Networking (SDN)-enabled controllers and switches 208. The network 204 is analogous to the network 112 of FIG. 1.

The applications unit 202 is shown to include a number of applications 206, for instance, for an enterprise. These applications are analyzed, monitored, searched, and otherwise crunched just like the applications from the plug-ins of the fabric system 106 for ultimate delivery to resources through the network 204.

The data center 100 is shown to include five units (or planes), the management unit 210, the value-added services (VAS) unit 214, the controller unit 212, the service unit 216 and the data unit (or network) 204. Accordingly and advantageously, control, data, VAS, network services and management are provided separately. Each of the planes is an agent and the data from each of the agents is crunched by the controller unit 212 and the VAS unit 214.

The fabric system 106 is shown to include the management unit 210, the VAS unit 214, the controller unit 212 and the service unit 216. The management unit 210 is shown to include a user interface (UI) plug-in 222, an orchestrator compatibility framework 224, and applications 226. The management unit 210 is analogous to the plug-in 108. The UI plug-in 222 and the applications 226 receive applications of various formats and the framework 224 translates the various formatted application into native-format applications. Examples of plug-ins 116, located in the applications 226, are VMware ICenter, by VMware, Inc. and System Center by Microsoft, Inc. While two plug-ins are shown in FIG. 2, it is understood that any number may be employed.

The controller unit 212 serves as the master or brain of the data center 100 in that it controls the flow of data throughout the data center and timing of various events, to name a couple of many other functions it performs as the mastermind of the data center. It is shown to include a services controller 218 and a SDN controller 220. The services controller 218 is shown to include a multi-cloud master controller 232, an application delivery services stitching engine or network enablement engine 230, a SLA engine 228, and a controller compatibility abstraction 234.

Typically, one of the clouds of a multi-cloud network is the master of the clouds and includes a multi-cloud master controller that talks to local cloud controllers (or managers) to help configure the topology among other functions. The master cloud includes the SLA engine 228 whereas other clouds need not to but all clouds include a SLA agent and a SLA aggregator with the former typically being a part of the virtual services platform 244 and the latter being a part of the search and analytics 238.

The controller compatibility abstraction 234 provides abstraction to enable handling of different types of controllers (SDN controllers) in a uniform manner to offload traffic in the switches and routers of the network 204. This increases response time and performance as well as allowing more efficient use of the network.

The network enablement engine 230 performs stitching where an application or network services (such as configuring load balance) is automatically enabled. This eliminates the need for the user to work on meeting, for instance, a load balance policy. Moreover, it allows scaling out automatically when violating a policy.

The flex cloud engine 232 handles multi-cloud configurations such as determining, for instance, which cloud is less costly, or whether an application must go onto more than one cloud based on a particular policy, or the number and type of cloud that is best suited for a particular scenario.

The SLA engine 228 monitors various parameters in real-time and decides if policies are met. Exemplary parameters include different types of SLAs and application parameters. Examples of different types of SLAs include network SLAs and application SLAs. The SLA engine 228, besides monitoring allows for acting on the data, such as service plane (L4-L7), application, network data and the like, in real-time.

The practice of service assurance enables Data Centers (DCs) and (or) Cloud Service Providers (CSPs) to identify faults in the network and resolve these issues in a timely manner so as to minimize service downtime. The practice also includes policies and processes to proactively pinpoint, diagnose and resolve service quality degradations or device malfunctions before subscribers (users) are impacted.

Service assurance encompasses the following:
Fault and event management
   Performance management
   Probe monitoring
   Quality of service (QoS) management
   Network and service testing
   Network traffic management
   Customer experience management
   Real-time SLA monitoring and assurance
   Service and Application availability
   Trouble ticket management

The structures shown included in the controller unit 212 are implemented using one or more processors executing software (or code) and in this sense, the controller unit 212 may be a processor. Alternatively, any other structures in FIG. 2 may be implemented as one or more processors executing software. In other embodiments, the controller unit 212 and perhaps some or all of the remaining structures of FIG. 2 may be implemented in hardware or a combination of hardware and software.

VAS unit 214 uses its search and analytics unit 238 to search analytics based on distributed large data engine and crunches data and displays analytics. The search and analytics unit 238 can filter all of the logs the distributed logging unit 240 of the VAS unit 214 logs, based on the customer's (user's) desires. Examples of analytics include events and logs. The VAS unit 214 also determines configurations such as who needs SLA, who is violating SLA, and the like.

The SDN controller 220, which includes software defined network programmability, such as those made by Floodlight, Open Daylight, POX, and other manufacturers, receives all the data from the network 204 and allows for programmability of a network switch/router.

The service plane 216 is shown to include an API based, Network Function Virtualization (NFV), Application Delivery Network (ADN) 242 and on a Distributed virtual services platform 244. The service plane 216 activates the right components based on rules. It includes Application Delivery Controller (ADC), web-application firewall, DPI, VPN, DNS and other L4-L7 services and configures based on policy (it is completely distributed). It can also include any application or L4-L7 network services.

The distributed virtual services platform contains an Application Delivery Controller (ADC), Web Application Firewall (Firewall), L2-L3 Zonal Firewall (ZFW), Virtual Private Network (VPN), Deep Packet Inspection (DPI), and various other services that can be enabled as a single-pass architecture. The service plane contains a Configuration agent, Stats/Analytics reporting agent, Zero-copy driver to send and receive packets in a fast manner, Memory mapping engine that maps memory via TLB to any virtualized platform/hypervisor, SSL offload engine, etc.

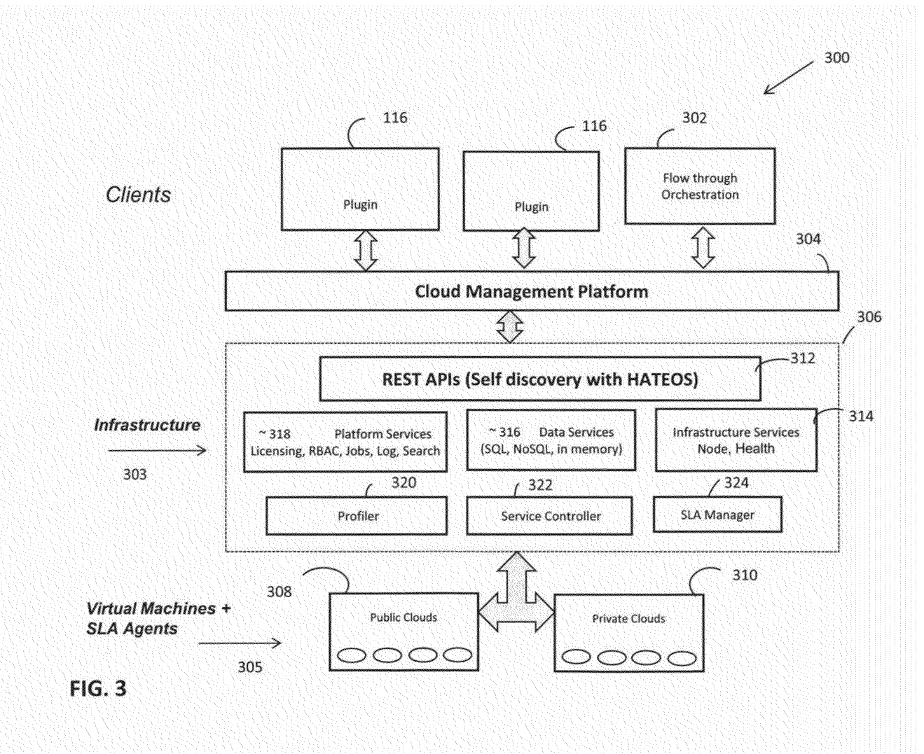

FIG. 3 shows conceptually various features of the data center 300, in accordance with an embodiment of the invention. The data center 300 is analogous to the data center 100 except some of the features/structures of the data center 300 are in addition to those shown in the data center 100. The data center 300 is shown to include plug-ins 116, flow-through orchestration 302, cloud management platform 304, controller 306, and public and private clouds 308 and 310, respectively.

The controller 306 is analogous to the controller unit 212 of FIG. 2. In FIG. 3, the controller 306 is shown to include a REST APIs-based invocations for self-discovery, platform services 318, data services 316, infrastructure services 314, profiler 320, service controller 322, and SLA manager 324.

The flow-through orchestration 302 is analogous to the framework 224 of FIG. 2. Plug-ins 116 and orchestration 302 provide applications to the cloud management platform 304, which converts the formats of the applications to native format. The native-formatted applications are processed by the controller 306, which is analogous to the controller unit 212 of FIG. 2. The RESI APIs 312 drive the controller 306. The platform services 318 is for services such as licensing, Role Based Access and Control (RBAC), jobs, log, and search. The data services 316 is to store data of various components, services, applications, databases such as Search and Query Language (SQL), NoSQL, data in memory. The infrastructure services 314 is for services such as node and health.

The profiler 320 is a test engine. Service controller 322 is analogous to the controller 220 and SLA manager 324 is analogous to the SLA engine 228 of FIG. 2. During testing by the profiler 320, simulated traffic is run through the data center 300 to test for proper operability as well as adjustment of parameters such as response time, resource and cloud requirements, and processing usage.

In the exemplary embodiment of FIG. 3, all structures shown outside of the private cloud 310 and the public cloud 308 are a part of the clouds 308 and 310 even though the structures, such as the controller 306, are shown located externally to the clouds 308 and 310. It is understood that in some embodiments of the invention, each of the clouds 308 and 310 may include one or more clouds and these clouds can communicate with each other. Benefits of the clouds communicating with one another is optimization of traffic path, dynamic traffic steering, and/or reduction of costs, among perhaps others.

The plug-ins 116 and the flow-through orchestration 302 are the clients 310 of the data center 300, the controller 306 is the infrastructure of the data center 300. Virtual machines and SLA agents 305 are a part of the clouds 308 and 310.

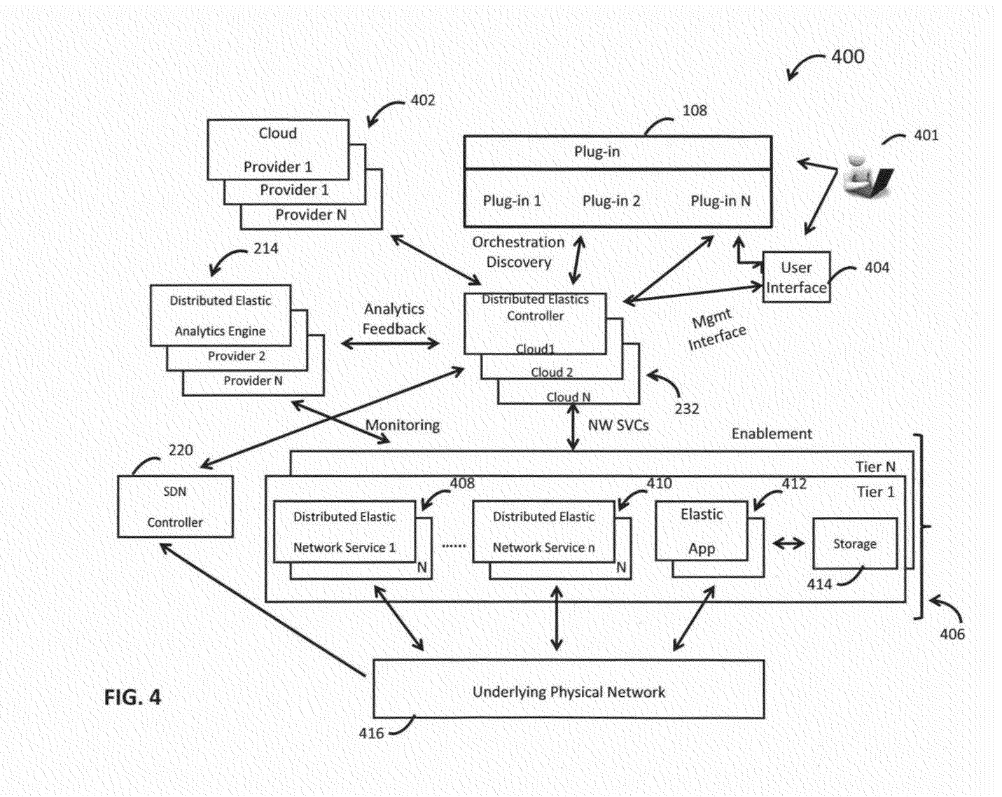

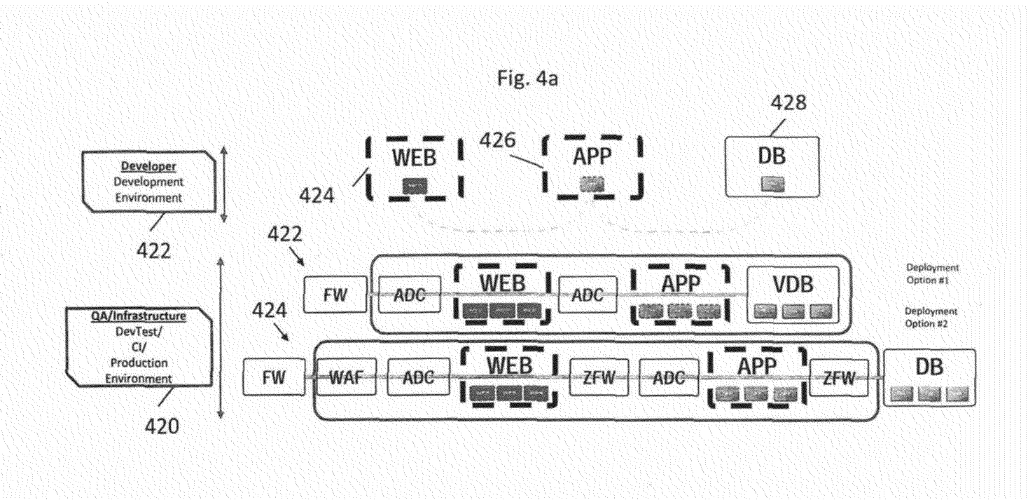

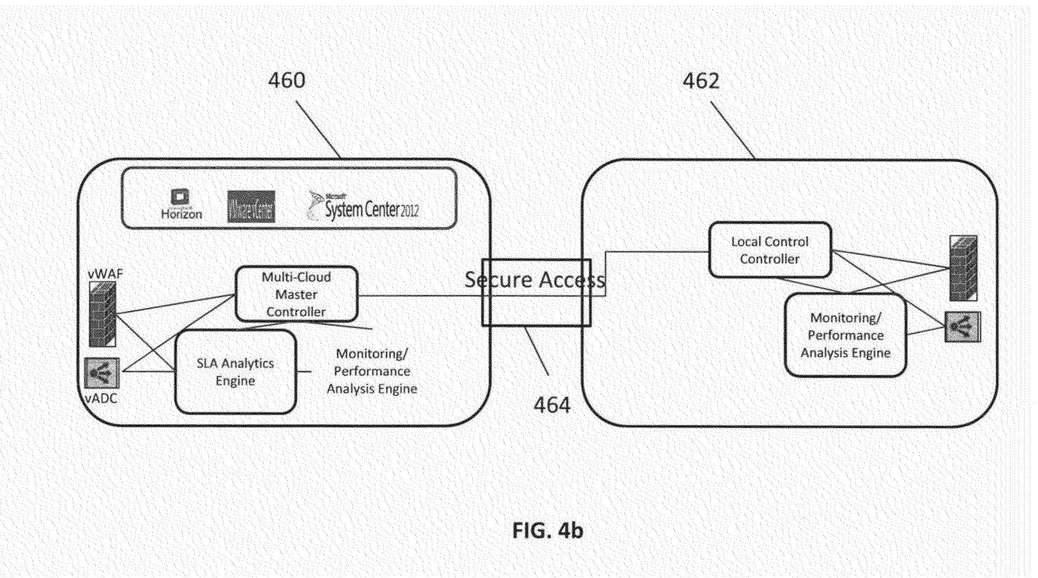

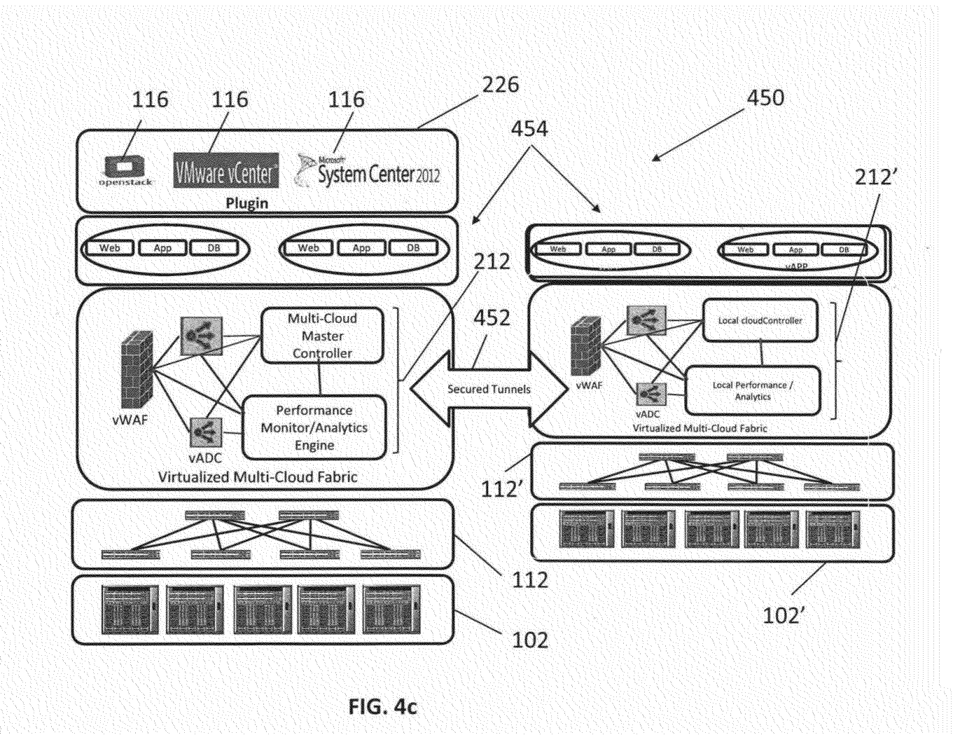

FIG. 4 shows, in conceptual form, relevant portion of a multi-cloud data center 400, in accordance with another embodiment of the invention. A client (or user) 401 is shown to use the data center 400, which is shown to include plug-in units 108, cloud providers 1-N 402, distributed elastic analytics engine (or “VAS unit”) 214, distributed elastic controller (of clouds 1-N) (also known herein as “flex cloud engine” or “multi-cloud master controller”) 232, tiers 1-N, underlying physical NW 416, such as Servers, Storage, Network elements, etc. and SDN controller 220.

Each of the tiers 1-N is shown to include distributed elastic 1-N, 408-410, respectively, elastic applications 412, and storage 414. The distributed elastic 1-N 408-410 and elastic applications 412 communicate bidirectional with the underlying physical NW 416 and the latter unilaterally provides information to the SDN controller 220. A part of each of the tiers 1-N are included in the service plane 216 of FIG. 2.

The cloud providers 402 are providers of the clouds shown and/or discussed herein. The distributed elastic controllers 1-N each service a cloud from the cloud providers 402, as discussed previously except that in FIG. 4, there are N number of clouds, “N” being an integer value.

As previously discussed, the distributed elastic analytics engine 214 includes multiple VAS units, one for each of the clouds, and the analytics are provided to the controller 232 for various reasons, one of which is the feedback feature discussed earlier. The controllers 232 also provide information to the engine 214, as discussed above.

The distributed elastic services 1-N are analogous to the services 318, 316, and 314 of FIG. 3 except that in FIG. 4, the services are shown to be distributed, as are the controllers 232 and the distributed elastic analytics engine 214. Such distribution allows flexibility in the use of resource allocation therefore minimizing costs to the user among other advantages.

The underlying physical NW 416 is analogous to the resources 114 of FIG. 1 and that of other figures herein. The underlying network and resources include servers for running any applications, storage, network elements such as routers, switches, etc. The storage 414 is also a part of the resources.

The tiers 406 are deployed across multiple clouds and are enablement. Enablement refers to evaluation of applications for L4 through L7. An example of enablement is stitching.

In summary, the data center of an embodiment of the invention, is multi-cloud and capable of application deployment, application orchestration, and application delivery.

In operation, the user (or “client”) 401 interacts with the UI 404 and through the UI 404, with the plug-in unit 108. Alternatively, the user 401 interacts directly with the plug-in unit 108. The plug-in unit 108 receives applications from the user with perhaps certain specifications. Orchestration and discover take place between the plug-in unit 108, the controllers 232 and between the providers 402 and the controllers 232. A management interface (also known herein as “management unit” 210) manages the interactions between the controllers 232 and the plug-in unit 108.

The distributed elastic analytics engine 214 and the tiers 406 perform monitoring of various applications, application delivery services and network elements and the controllers 232 effectuate service change.

In accordance with various embodiments and methods of the invention, some of which are shown and discussed herein, an Multi-cloud fabric is disclosed. The Multi-cloud fabric includes an application management unit responsive to one or more applications from an application layer. The Multi-cloud fabric further includes a controller in communication with resources of a cloud, the controller is responsive to the received application and includes a processor operable to analyze the received application relative to the resources to cause delivery of the one or more applications to the resources dynamically and automatically.

The multi-cloud fabric, in some embodiments of the invention, is virtual. In some embodiments of the invention, the multi-cloud fabric is operable to deploy the one or more native-format applications automatically and/or dynamically. In still other embodiments of the invention, the controller is in communication with resources of more than one cloud.

The processor of the multi-cloud fabric is operable to analyze applications relative to resources of more than one cloud.

In an embodiment of the invention, the Value Added Services (VAS) unit is in communication with the controller and the application management unit and the VAS unit is operable to provide analytics to the controller. The VAS unit is operable to perform a search of data provided by the controller and filters the searched data based on the user's specifications (or desire).

In an embodiment of the invention, the multi-cloud fabric system 106 includes a service unit that is in communication with the controller and operative to configure data of a network based on rules from the user or otherwise.

In some embodiments, the controller includes a cloud engine that assesses multiple clouds relative to an application and resources. In an embodiment of the invention, the controller includes a network enablement engine.

In some embodiments of the invention, the application deployment fabric includes a plug-in unit responsive to applications with different format applications and operable to convert the different format applications to a native-format application. The application deployment fabric can report configuration and analytics related to the resources to the user. The application deployment fabric can have multiple clouds including one or more private clouds, one or more public clouds, or one or more hybrid clouds. A hybrid cloud is private and public.

The application deployment fabric configures the resources and monitors traffic of the resources, in real-time, and based at least on the monitored traffic, re-configure the resources, in real-time.

In an embodiment of the invention, the Multi-cloud fabric can stitch end-to-end, i.e. an application to the cloud, automatically.

In an embodiment of the invention, the SLA engine of the Multi-cloud fabric sets the parameters of different types of SLA in rea-time.

In some embodiments, the Multi-cloud fabric automatically scales in or scales out the resources. For example, upon an underestimation of resources or unforeseen circumstances requiring addition resources, such as during a super bowl game with subscribers exceeding an estimated and planned for number, the resources are scaled out and perhaps use existing resources, such as those offered by Amazon, Inc. Similarly, resources can be scaled down.

The following are some, but not all, various alternative embodiments. The multi-cloud fabric system is operable to stitch across the cloud and at least one more cloud and to stitch network services, in real-time.

The multi-cloud fabric is operable to burst across clouds other than the cloud and access existing resources.

The controller of the multi-cloud fabric receives test traffic and configures resources based on the test traffic.

Upon violation of a policy, the multi-cloud fabric automatically scales the resources.

The SLA engine of the controller monitors parameters of different types of SLA in real-time.

The SLA includes application SLA and networking SLA, among other types of SLA contemplated by those skilled in the art.

The multi-cloud fabric may be distributed and it may be capable of receiving more than one application with different formats and to generate native-format applications from the more than one application.

The resources may include storage systems, servers, routers, switches, or any combination thereof.

The analytics of the multi-cloud fabric include but not limited to traffic, response time, connections/sec, throughput, network characteristics, disk I/O or any combination thereof.

In accordance with various alternative methods, of delivering an application by the multi-cloud fabric, the multi-cloud fabric receives at least one application, determines resources of one or more clouds, and automatically and dynamically delivers the at least one application to the one or more clouds based on the determined resources. Analytics related to the resources are displayed on a dashboard or otherwise and the analytics help cause the Multi-cloud fabric to substantially optimally deliver the at least one application.

FIGS. 4a-c show exemplary data centers configured using embodiments and methods of the invention. FIG. 4a shows the example of a work flow of a 3-tier application development and deployment. At 422 is shown a developer's development environment including a web tier 424, an application tier 426 and a database 428, each used by a user for different purposes typically and perhaps requiring its own security measure. For example, a company like Yahoo, Inc. may use the web tier 424 for its web and the application tier 426 for its applications and the database 428 for its sensitive data. Accordingly, the database 428 may be a part of a private rather than a public cloud. The tiers 424 and 426 and database 420 are all linked together.

At 420, development testing and production environment is shown. At 422, an optional deployment is shown with a firewall (FW), ADC, a web tier (such as the tier 404), another ADC, an application tier (such as the tier 406), and a virtual database (same as the database 428). ADC is essentially a load balancer. This deployment may not be optimal and actually far from it because it is an initial pass and without the use of some of the optimizations done by various methods and embodiments of the invention. The instances of this deployment are stitched together (or orchestrated).

At 424, another optional deployment is shown with perhaps greater optimization. A FW is followed by a web-application FW (WFW), which is followed by an ADC and so on. Accordingly, the instances shown at 424 are stitched together.

FIG. 4b shows an exemplary multi-cloud having a public, private, or hybrid cloud 460 and another public or private or hybrid cloud 464 communication through a secure access 464. The cloud 460 is shown to include the master controller whereas the cloud 462 is the slave or local cloud controller. Accordingly, the SLA engine resides in the cloud 460.

FIG. 4c shows a virtualized multi-cloud fabric system spanning across multiple clouds with a single point of control and management.

In accordance with embodiments and methods of the invention, load balancing is done across multiple clouds.

Although the description has been described with respect to particular embodiments thereof, these particular embodiments are merely illustrative, and not restrictive.

Disclosed herein are methods and apparatus for creating and publishing user interface (UI) for any cloud management platform with centralized monitoring, dynamic orchestration of applications with network services, with performance and service assurance capabilities across multi-clouds.

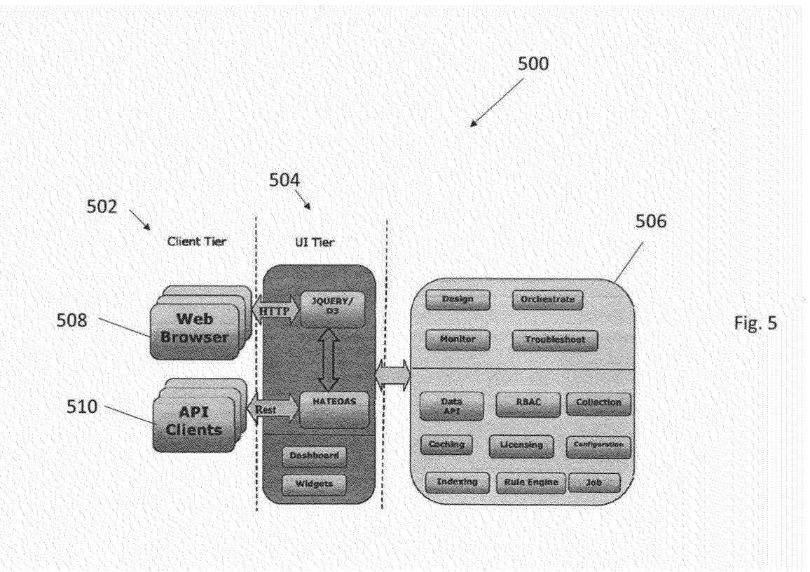

FIG. 5 shows a system 500 for generating UI screenshots, in a networking system, defining tiers and profiles. A hierarchal dashboard is shown starting from projects to applications to tiers and to virtual machines (VMs).

For example, client tier 502, UI tier 504 and networking functions 106 are shown where the client tier 502 includes a web browser 508 that is in communication with a jquery or D3 in the UI tier 504 through HTTP and an API clients 510 of the client tier 102 is shown in communication with a hateoas of the UI tier 104 through REST. The UI tier 104 is also shown to include a dashboard and widgets (desired graphics/data).

The network functions 506 is shown in communication with the UI tier 504 and includes functions such as orchestration, monitoring, troubleshooting, data API, and so forth, which are merely examples of many others.

In operation, projects start at client tier 502, such as the web server 508, resulting in applications in the UI tier 504 and multiple tiers.

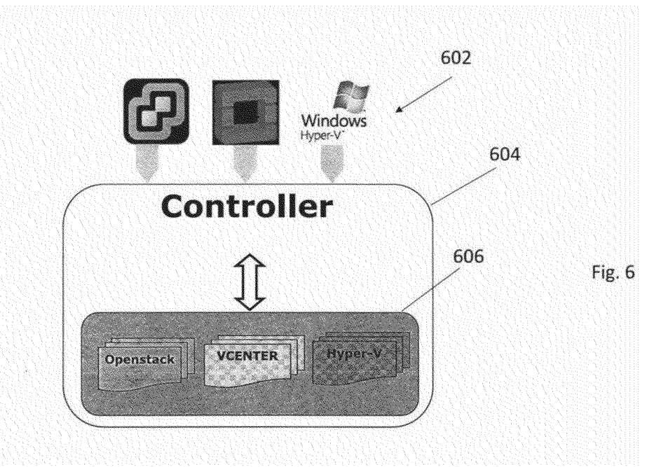

FIG. 6 shows a portion of a multi-cloud fabric system 602/106 including a controller 604. The controller 604 is shown to receive information from various types of plug-in 603. It provides the method to expose that consists of all of the definition files which are needed for publishing the user for respective cloud management platform (CMP).

The plugin, such as one of the plugins 603, is installed on the CMP during load up time, and fetches the definition files from the controller 604 describing the complete workflow compliant with the respective CMP thereby eliminating the need for any update in the CMP for any changes in the workflow.

further details of the controller 604 of FIG. 6, in accordance with an embodiment of the invention. The controller 604 may be thought of as a multi-cloud master controller as it can manage multiple clouds.

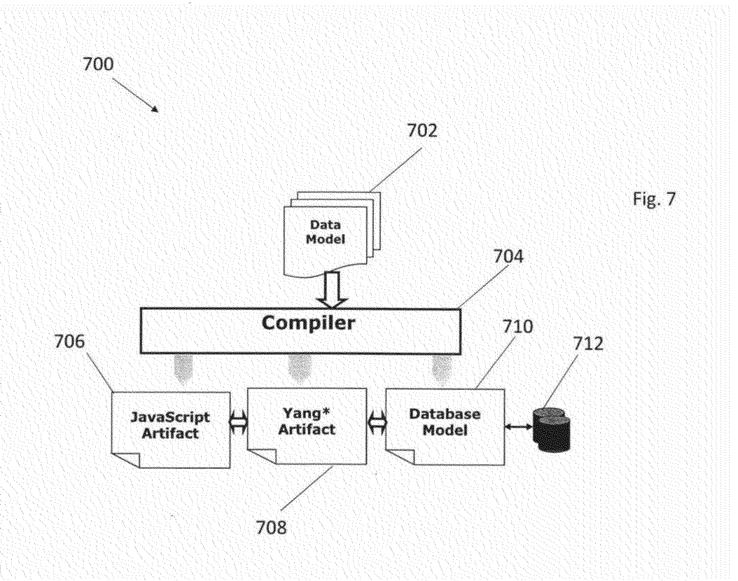

FIG. 7 shows a build server 700 used to generate an image of a UI. The server 700 is shown to include data model(s) 702, a compiler 704, and artifacts 706 and 708, in addition to a database model 710 and database 712.

The data model 702 is shown to be in communication with the complier 704. The compiler 704 is shown to be in communication with various components, such as the database model 710, which is transmitted to and from the database 712. Further shown to be in communication with the compiler 704 are the Java script artifact 706 and the Yang artifact 708. It should be noted that these are merely two examples of artifacts. The artifact 706 is also in communication with the Yang artifact 708, which is in turn in communication with the data base model 710.

The compiler 704 receives an input model, i.e. data model 702, and automatically creates both the client side (such as client tier 502) and server side artifacts (such as artifacts 706 and 708) in addition to the data base model 710, needed for creation and publishing of the User Interface (UI). The data base model 710 is saved and retrieved from the database 712. The database model 710 is used by the UI to retrieved and save inputs from users.

A unique model of deploying multi-tiered VM's working in conjunction to offer the characteristics desired from an application are realized by the methods and apparatus of the invention. The unique characteristics being: Automatic stitching of network services required for tier functioning; and service-level agreement (SLA)-based auto-scaling model in each of the tiers.

Accordingly, the compiler 704 of the multi-cloud fabric system 106 of the data center 100 uses one or more data model(s) 702 to generate artifacts for use by a (master or slave) controller of a cloud, such as the clouds 1002-1006, thereby automating the process of building an UI to be input to the UI tier 504. To this end, artifacts are generated for orchestrated infrastructures automatically and a data-driven, rather than a manual approach, is employed, which can also be done among numerous clouds and clouds of different types.

The output of the compiler 704 is the combination of artifacts 706 and 708, and the database model 710 which in turn are used for creating the UI. The UI is then uploaded to (or used by) the servers 1012, 1014 and/or 1016 is an image of the UI and provided to the UI tier 504 of FIG. 5.

The UI of UI tier 504 may display a dashboard showing various information to a user. UI tier 504, as shown in FIG. 5, also receives information from the network functions 506 that can be used by the UI tier 504 to display on the dashboard. Such information includes but is not limited to features relating to design, orchestration, monitoring, troubleshooting, data API, caching, rule engine, licensing, . . .

In an embodiment and method of the invention, the compiler 704 generates artifacts based on the (master or slave) controller of the servers 1012, 1014, and/or 1016.

In an embodiment and method of the invention, the compiler 704 generates different artifacts for different controllers, for example, controllers of different clouds and cloud types.

The data model 702 used by the compiler 704 is defined for the UI to be created, on an on-demand basis and typically when clouds are being added or removed or features and being added or removed and a host of other reasons. The data model may be in any desired format, such as without limitation, XML.

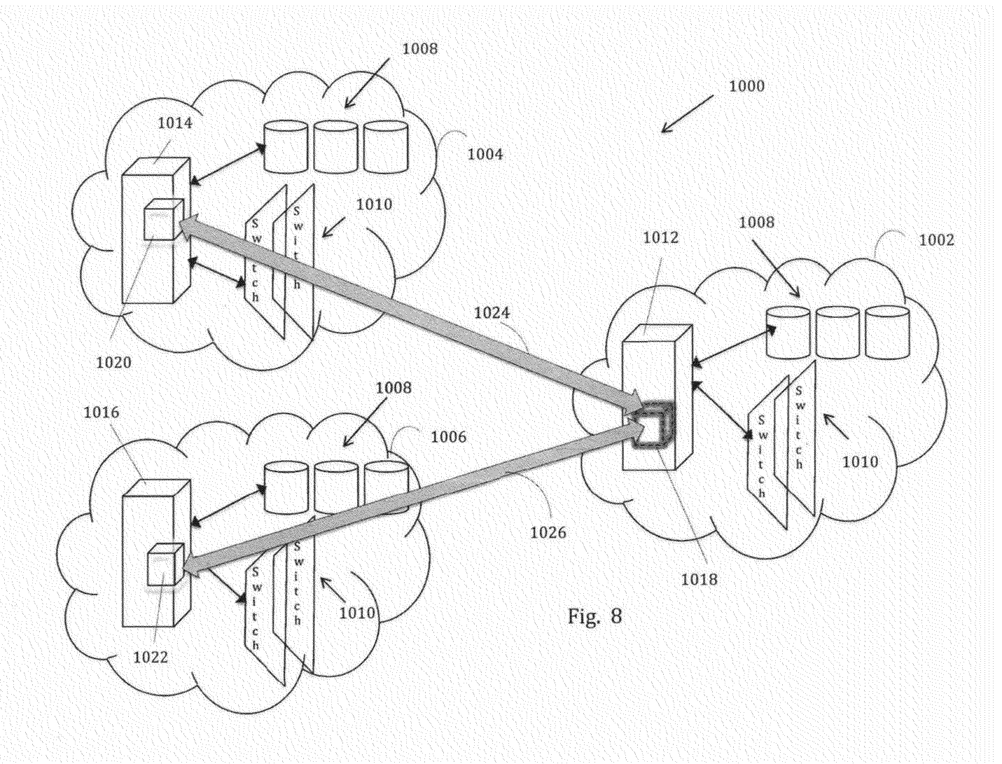

FIG. 8 shows a networking system 1000 using various methods and embodiments of the invention. The system 1000 is analogous to the data center 100 of FIG. 1, but shown to include three clouds, 1002-1006, in accordance with an embodiment of the invention. It is understood that while three clouds are shown in the embodiment of FIG. 8, any number of clouds may be employed without departing from the scope and spirit of the invention.

Each server of each cloud, in FIG. 8, is shown to be communicatively coupled to the databases and switches of the same cloud. For example, the server 1012 is shown to be communicatively coupled to the databases 1008 and switches 1010 of the cloud 1002 and so on.

Each of the clouds 1002-1006 is shown to include databases 1008 and switches 1010, both of which are communicatively coupled to at least one server, typically the server that is in the cloud in which the switches and databases reside. For instance, the databases 1008 and switches 1010 of the cloud 1002 are shown coupled to the server 1012, the databases 1008 and switches 1010 of cloud 1004 are shown coupled to the server 1014, and the databases 1008 and switches 1010 of cloud 1006 are shown coupled to the server 1016. The server 1012 is shown to include a multi-cloud master controller 1018, which is analogous to the multi-cloud master controller 232 of FIG. 2. The server 1014 is shown to include a multi-cloud fabric slave controller 1020 and the server 1016 is shown to include a multi-cloud fabric controller 1022. The controllers 1020 and 1022 are each analogous to each of the slave controllers in 930 and 932 of FIG. 5.

Clouds may be public, private or a combination of public and private. In the example of FIG. 8, cloud 1002 is a private cloud whereas the clouds 1004 and 1006 are public clouds. It is understood that any number of public and private clouds may be employed. Additionally, any one of the clouds 1002-1006 may be a master cloud.

In the embodiment of FIG. 8, the cloud 1002 includes the master controller but alternatively, a public cloud or a hybrid cloud, one that is both public and private, may include a master controller. For example, either of the clouds 1004 and 1006, instead of the cloud 1002, may include the master controller.

In FIG. 8, the controllers 1020 and 1022 are shown to be in communication with the controller 1018. More specifically, the controller 1018 and the controller 1020 communicate with each other through the link 1024 and the controllers 1018 and 1022 communicate with each other through the link 1026. Thus, communication between clouds 1004 and 1006 is conveniently avoided and the controller 1018 masterminds and causes centralization of and coordinates between the clouds 1004 and 1006. As noted earlier, some of these functions, without any limitation, include optimizing resources or flow control.

In some embodiments, the links 1024 and 1026 are each virtual personal network (VPN) tunnels or REST API communication over HTTPS, while others not listed herein are contemplated.

As earlier noted, the databases 1008 each maintain information such as the characteristics of a flow. The switches 1010 of each cloud cause routing of a communication route between the different clouds and the servers of each cloud provide or help provide network services upon a request across a computer network, such as upon a request from another cloud.

The controllers of each server of each of the clouds makes the system 1000 a smart network. The controller 1018 acts as the master controller with the controllers 1020 and 1022 each acting primarily under the guidance of the controller 1018. It is noteworthy that any of the clouds 1002-1006 may be selected as a master cloud, i.e. have a master controller. In fact, in some embodiments, the designation of master and slave controllers may be programmable and/or dynamic. But one of the clouds needs to be designated as a master cloud. Many of the structures discussed hereinabove, reside in the clouds of FIG. 8. Exemplary structures are VAS, SDN controller, SLA engine, and the like.

In an exemplary embodiment, each of the links 1024 and 1026 use the same protocol for effectuating communication between the clouds, however, it is possible for these links to each use a different protocol. As noted above, the controller 1018 centralizes information thereby allowing multiple protocols to be supported in addition to improving the performance of clouds that have slave rather than a master controller.

While not shown in FIG. 8, it is understood that each of the clouds 1002-1006 includes storage space, such as without limitation, solid state disks (SSD), which are typically employed in masses to handle the large amount of data within each of the clouds.

The build server 700 sends the output of the complier 704 to the UI tier 504 of FIG. 5. Practically, among the mechanisms this may be done with, one is using an installation script, generated by the build server 700, that is ultimately uploaded to the UI tier 504 though this is merely one example of a host of others including the use of hardware. The script essentially includes an image of the UI the user is to use and built by the build server 700. While not shown, in some embodiments, the output of the controller 604 of FIG. 6 is combined with the output of the compiler 704 to create the UI image that is uploaded to the UI tier 504. An updated installation script is generated by the build server 700 of FIG. 7, when needed, for example, when additional clouds are added or clouds are removed or features are added and the like.

The controller 604, of FIG. 6, is analogous to the master controller 1018 of FIG. 8. Alternatively, it may be a part of a slave cloud, such as the controllers 1020 and 1022 or it may be a part of all the controllers of all of the clouds 1002-1006.

The build server 700 may be externally located relative to the clouds and its output provided to a user for upload onto the UI tier 504, which would reside in the cloud, i.e. the servers 1012, 1014, and/or 1016.

In accordance with another embodiment of the invention, dynamic network access controlling is performed to allow selected peopled who are normally blocked from accessing certain resources. Policies are used to guide data packets' traffic flow in allowing such access. To this end, dynamic threat management and optimization are performed. In the event of much traffic, L7 ADC load balancers are offloaded to L4 ADC load balancers.

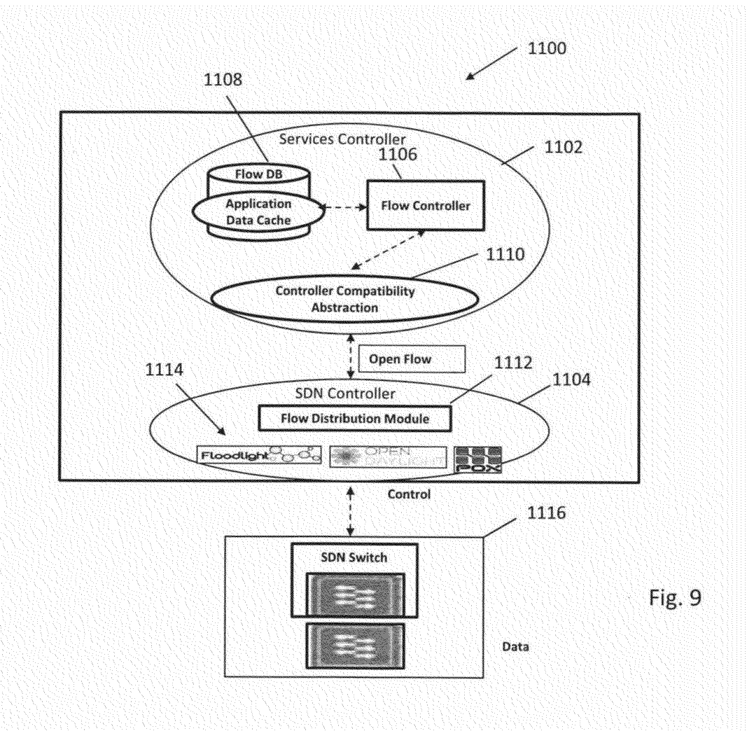

Referring now to FIG. 9, a data center 1100 is shown, in accordance with an embodiment of the invention. The data center 1100 is analogous to the data center 100 of FIG. 9. The data center 1100 of FIG. 9 is shown to include a services controller 1102, a SDN controller 1104, and SDN switch(es) 1116. The services controller 1102 of FIG. 9 is analogous to the services controller 218 of FIG. 2 and the SDN controller 1104 is analogous to the SDN controller 220 of FIG. 2 and the SDN switches 1116 of FIG. 9 is analogous to the switches 208 of FIG. 2.

The services controller 1102 of FIG. 9 is shown to include a (path) flow database 1108, a (path) flow controller module 1106, and a controller compatibility abstraction block 1110. The SDN controller 1104 is shown to include a flow distribution module 1112 and a group of controllers 1114, which are commercially-available and can be a mix of open-flow or open-source controllers. The switches 1116 are comprised of one or more SDN switches.

The type of communication between the switches 1116 and the services controller 1102, through the SDN controller, is primarily control information. The switches 1116 provide data to another layer of network equipment, such as servers and routers (not shown in FIG. 9). In accordance with an embodiment of the invention, the services controller 1102 and the SDN controller 1104 communicate through a NORTHBOUND REST (Representational State Transfer) API.

The SDN controller 1104 programs the SDN switches 1116 in a flow-based manner, either as shown in FIG. 9 or through a third-party's device. An example of such a third party is Cisco, Inc., provider of the product 1PK. The controller compatibility abstraction block 1110 allows various different types of SDN controllers to communicate with each other. It also programs actions to redirect packets of data to other network services that help in learning the application/layer 4-7 protocol information of the traffic. The flow controller module 1106, in association with the flow database 1108, an application data cache, and the SDN switches, achieve various functionalities such as dynamic network access control, dynamic threat management and various service plane optimizations.

Dynamic network access control is the process of determining whether to allow or deny access to the network by devices using authentication based on the application or subscriber information gleaned from the packet data. Further explanation of the functionality of some of the foregoing components is shown and discussed relative to subsequent figures.

Dynamic threat management is the process of detecting threats in real time and taking actions to dynamically redirect the traffic to nodes that can quarantine the flow of data traffic and learn more about the threat for the purpose of dealing with it in a more direct manner in the future. An example is detection of a similar threat in the future that would result in automatic redirection of traffic to a trusted application that replicates the actual application.

Various control and service plane optimizations that can be achieved using the dynamic programmability aspect of the SDN switches and real time learning of network traffic are discussed in subsequent paragraphs.

Optimization of server-backups in data centers that use SDN, such as the embodiment of FIG. 9, is achieved by constantly learning about the traffic patterns and where the links are congested. The output of this learning process leads to determining optimal paths and re-routing the paths via dynamic programming of the SDN-based Layer 2 switches. This is achieved by the services controller 1102 invoking the appropriate Northbound REST APIs of the SDN controller 1106 which in turn re-programs the flows on the SDN-based Layer 2 switches.

Via traffic steering, dynamic high availability (HA), load balancing and upgrades may be made advantageously through SDN as opposed to, for example, using Linux-based or customer-specified devices to perform load balancing, done currently by prior art systems, which results in inefficiency and unnecessary complexity.

Fully automated networks are created, in accordance with methods and embodiments of the invention, by dynamically expanding/shrinking with auto steering-dynamic HA for any services/applications such as a firewall. Accordingly, upgrades are made easy by using SDN via dynamic traffic steering, also referred to as “service chaining”.

Further, adaptive bit rate (ABR) is done for video using SDN by having multiple servers, such as ones for video and others for other type of traffic. Based on how congested the links are, determining which server is best to use based on link and number of flows (configuration) and bit rate. Based on this determination, changing the traffic flow so that the traffic is directed to the server that is determined to be the best server for the particular use at hand. This determination is continually changing where different servers are employed based on what they are well, or better, suited for given the conditions at hand. A practical example is to determine that the traffic is video traffic and using a video server accordingly, but that some time later, the traffic changes and is no longer video traffic, the traffic is then re-directed to another suitable server rather than the video server.

Thus, in accordance with an embodiment and method of the invention, an open flow switch between the services controller 1102 and the SDN controller 1104 receives a first and subsequent data packets. The services controller saves the flow entries in the flow database 1108. Upon the receipt of the first data packet, the open flow switch directs the first packet to the services controller 1102, and may or may not create a flow entry depending upon whether one already exists or not. The services controller 1102 makes authentication decisions based on authentication information. Based on authentication policies, the open flow controller determines to allow or deny access to a corporate network based on authentication policies and if the open flow controller determines to deny access, the first packet is re-directed to an authentication server for access. For instance, corporations typically allow access to information by employees and officers on a need-to-know basis. Highly sensitive data may not be accessible to applications of most employees' devices, such as hand-held tablets and iPhones. Additionally, access may change throughout time based on the employees' job functions. Most employees' access to sensitive information may need to be blocked whereas a smaller group of employees may be allowed access. To this end, applications running on the former employees' devices are denied access to certain information perhaps residing on servers whereas applications on the latter group of employees' devices are allowed access after authentication. The data center 1100 achieves the same by performing the foregoing process and those to be discussed blow and shown in figures herein, dynamically and in real-time.

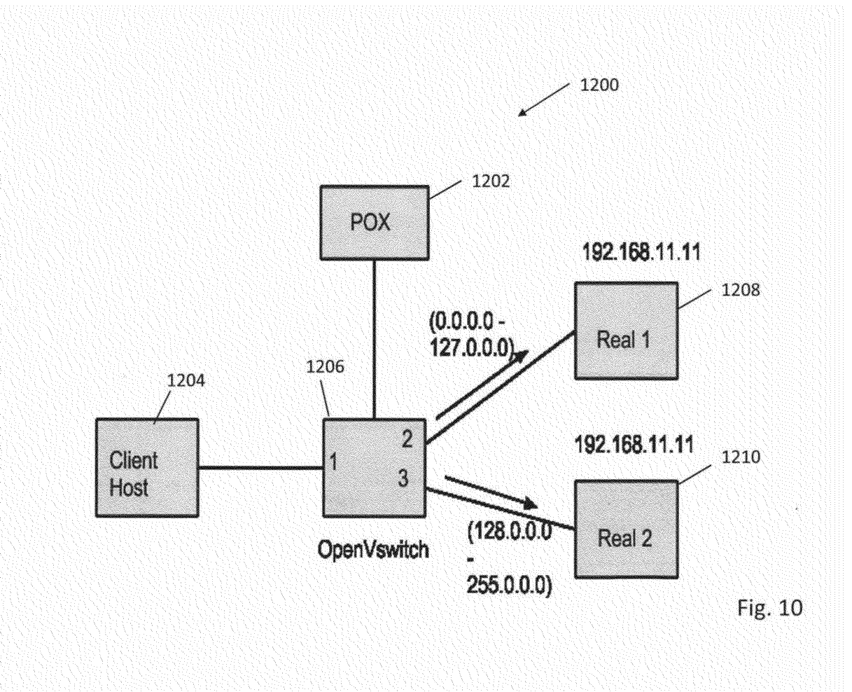

FIG. 10 shows a load balancing system 1200, in accordance with another method and embodiment of the invention. The load balancing system 1200 is shown to include a controller (an example of which is “POX”) 1202, two back-end servers 1208 and 1210, a client host 1204, and a switch 1204. The controller 1202 is an intelligent SDN-based open-flow controller that performs L4 load balancing by dynamically programming the switch 1206. Any controller that can dynamically program the switch 1206 is suitable. FIG. 10 essentially shows using the SDN capability of the services controller 1102 to offload L-4 load balancing feature through an openVswitch. As will be further explained below, traffic is split based on an IP address (or hashing). In some embodiments, L7 ADC needs to be confronted by a L4 ADC. Therefore, L7 load balancing is being offloaded to L4 load balancing.

The controller 1202 is shown to be in communication with the servers 1208 and 1210 through the switch 1206. As noted above, the controller 1202 can dynamically program the switch 1206, which is shown to be in communication with the client host 1204. An example of a client host is an iPad or a personal computer or any web site trying to access the network. Pro-active rules are used to program the switch 1206 based on apriori knowledge of traffic by, for example, a services controller. The switch 1206 is used as a L4 load balancer, which reduces costs. This is an example of the optimization performed by the services controller 1102.

In an exemplary embodiment of the invention, the server 1208 is any L7-based network server. If any of the servers 1208 or 1210 go down, traffic is re-directed to the other by the switch 1206, accordingly, traffic flow is not affected and appear seamless to the user/client.

The numbers appearing in FIG. 10, such as “(0.0.0.0-127.0.0.0)”, are IP address ranges. The switch 1206 is an open-flow switch that switches between the servers 1208 and 1210 to direct traffic accordingly and dynamically. As shown, the switch 1206 splits traffic from the client host 1204 based on the IP addresses of server 1208 and server 1210.

In some embodiments of the invention, meta-data is extracted from incoming packets (content) (of information or data), using L4-L7 service elements. Device (or “services controller”) is used to extract meta-data from any L4-L7 service, such as but not limited to HTTP, DPI, IDS, firewall (FW), and others too many to list herein but contemplated. The device or services controller 1102 applies network-based actions such as the following:
Blocking traffic
Re-routing traffic
Apply quality-of-service (QOS) policies, such as giving one application priority over another application
Bandwidth and any other network policy

In another embodiments of the invention, subscriber information (information about who is trying to access) is extracted from policy control and rule function (PCRF) and other policy servers and the extracted information, such as but not limited to analytics, is used to dynamically apply network actions to the subscriber traffic.

In yet another embodiment of the invention, extracted analytics information by using protocol in packets, i.e. source, destination, and the like, based on 5 tuple is used as the analytics engine output to apply network actions thereto.

In another embodiment, based on apriority information, that which has been learned, apply network actions and a suitable caching technique can be used to learn the traffic flow, subscriber information regarding the content and determine adaptive network actions accordingly.

In yet another embodiment and method of the invention, the meta data obtained from various L4-L7 services can be pushed to various VAS such as an analytics engine, PCRF, Radius, and the like, to generate advanced network actions (based on information from both L4-L7 actions and VAS. That is, meta-data obtained from various L4-L7 services can be passed to third parties and from third party rules, actions that need to be applied can be performed.

In yet another embodiment and method of the invention, load information and other information from any orchestration system can be used to determine not only compatibility issues of various network elements, VAS, but also services chains, network actions, optimizing traffic paths, and other relevant analytics. Examples of other information are how loaded net services are in the future, rate-limited traffic to avoid overload, and the like. Further, information from the network elements may be collected to determine optimal and dynamic service chains. The collection of information is based on L4-L7 information and learned optimal path based on load information, extracted meta-data, and other suitable information

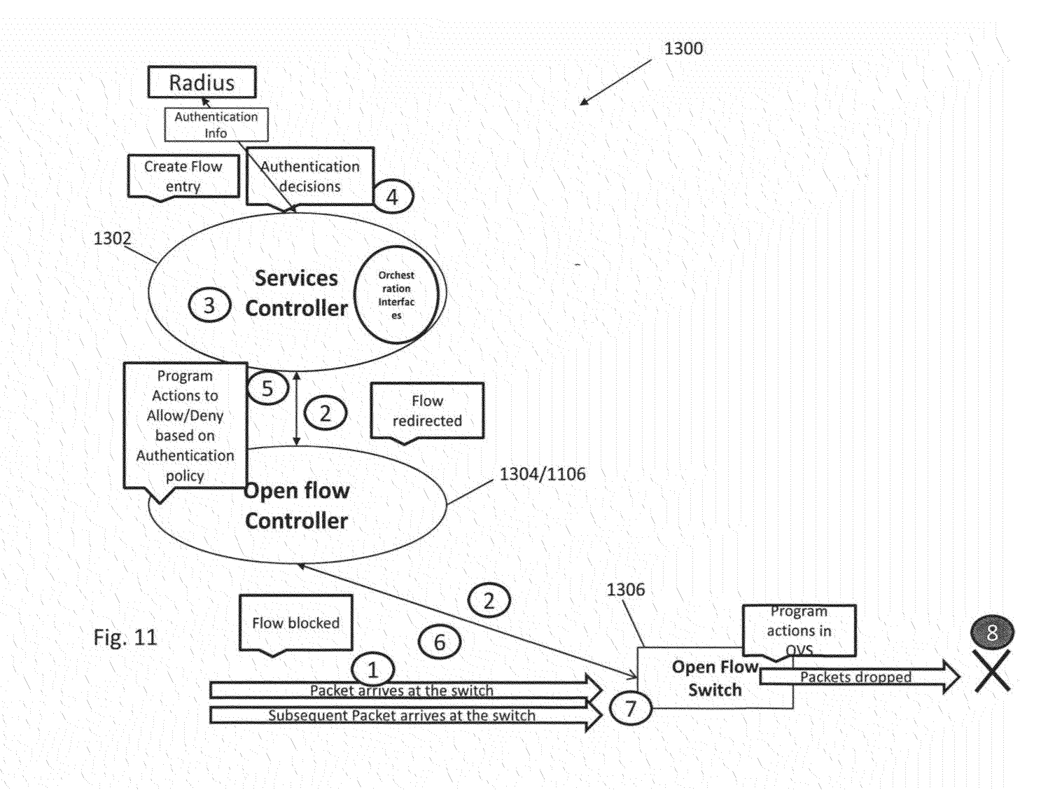

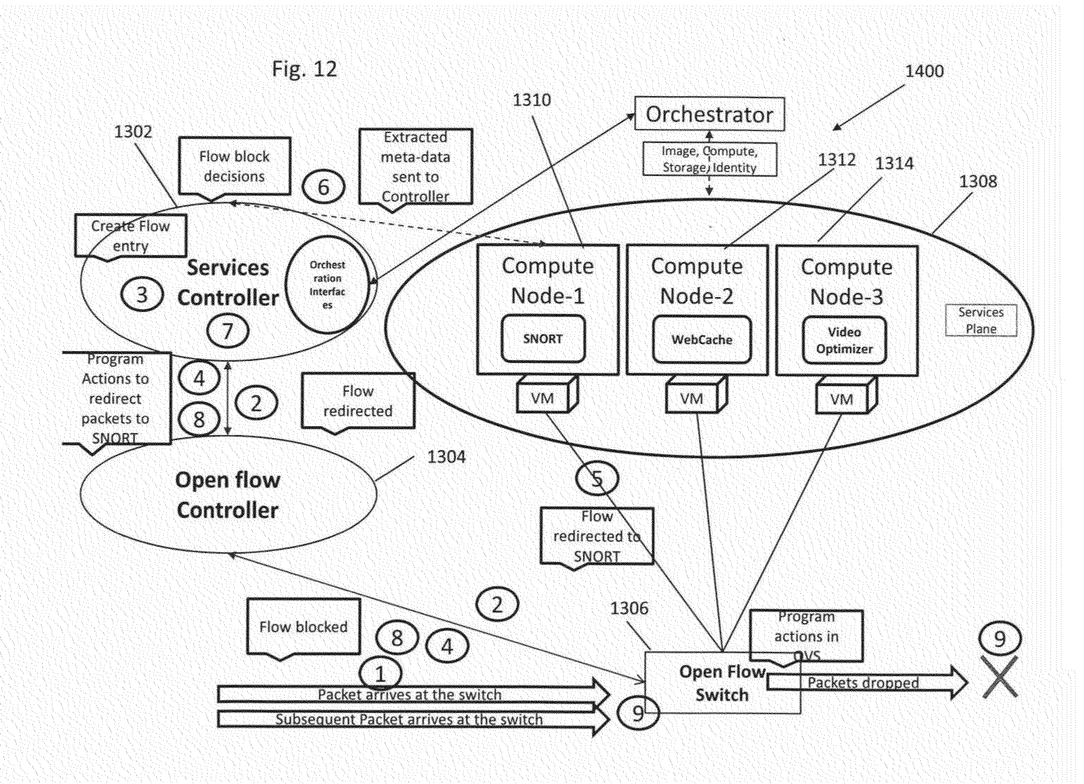

FIGS. 11-12 shows data packet flow paths that are dynamically and in real-time altered, through the data center 1100, in accordance with various methods and embodiments of the invention.

FIG. 11 shows a flow of information of a network access control, in accordance with a method and embodiment of the invention. In FIG. 11, a services controller 1302, analogous to the services controller 1102, is shown to be in communication with an open flow switch 1306, through an open flow controller 1304.

A data packet comes in to the switch 1306, at 1, and the switch 1306 directs the packets to the open flow controller 1304. Thereafter, the packet is sent to the open flow controller 1304, at 2. Next, the services controller 1302 receives the packet at 3 and makes authentication decisions based on authentication policies, at 4. Also, a flow entry is created by the services controller if one does not exist and the services controller performs orchestration. Next at 5, the open flow controller 1304 programs actions to allow or to deny access based on the authentication policies from the services controller 1102. Accordingly, the flow of packets may be re-directed at 6. Subsequent packets arrive at the switch 1306, and at 7, actions are taken, such as, without limitation, dropping a packet is taken at 8. Accordingly, authenticated devices are allowed access to corporate network and un-authenticated devices can be re-directed to authentication server(s) to obtain access. Also, authorized devices reach a specific domain. Policies or rules, which may be used to make authentication decisions, are based on the application that is trying to gain access. To use the example above, an employee's device, i.e. iPad or smart phone, runs applications that may be denied access to certain corporate information residing on servers. This information is applied by way of authentication information.

FIG. 11 is one example of the flow of information with many others anticipated. The flow of data packets in FIG. 11, is an example of obtaining access to a corporate network by authenticated devices, after they have been authenticated, and the data packets directed to un-authenticated devices can be redirected to an authentication server to obtain access. Upon authorization, authorized devices reach a specific (intended) domain and rules are based on the application and the endpoint of the flow authorization.

In FIG. 11, packets arrive at the switch, for example switch 1206 of FIG. 10, at “1”. Numbers such as “1” and “2”, . . . “8”, shown encircled in FIG. 11, are data packets' flow path. The packets travel through the open-flow switch 1306 and at “2”, are communicated to the open flow controller 1304. At “3”, the services controller 1302 acts upon the arrived packets. For example, a determination is made is as to whether or not, the subscriber is allowed is by using the Radius to find authentication information, programming to accept or deny based on an application or a subscriber. Radius has rules for policies for authentication based on subscriber and applications. In some embodiments of the invention, Radius is a server or a virtual machine.

Authentication decisions are made at “4” based on authentication information from the Radius. Orchestration is done and actions are programmed to allow or deny access based on an authentication policy, at “5” and “6”.

The open flow controller 1304 is programmed to send a copy of packets received from the switch 1306.

In the example of FIG. 11, the packet(s) are dropped at “8”. Similarly, in the example of FIG. 12, packets are dropped at “9”but in FIG. 12, an example of a dynamic threat management is shown in flow diagram form.

The embodiment and method of FIG. 12 is similar to that of FIG. 11 except that a services plane 308 is shown to include VMs 1310-1314 with each VM having a distinct purpose, such as SNORT, web cache, and video optimizer, respectively. In the example of FIG. 12, flow of packets is blocked at “8” and packets are redirected to the SNORT VM 310, at “5”, based on flow block decisions made by the services controller 302.

In accordance with various embodiments and methods of the invention, identification of which subscriber traffic is for is made and used as traffic characteristics for decision-making. For example, such subscriber-awareness, VoIP or video traffic, or pure traffic (traffic characteristics), are used to dynamically adjust characteristics of the network, such as programming the L2 switches accordingly.

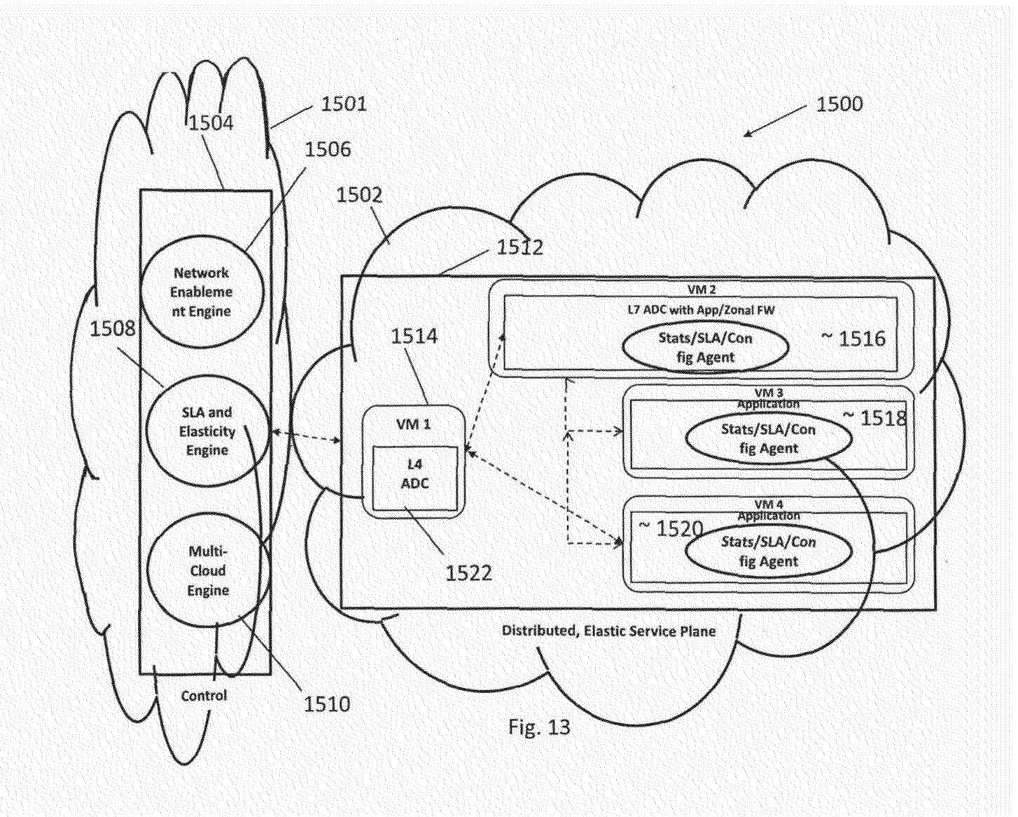

FIG. 13 shows a multi-cloud environment 1500 with two clouds 1501 and 1502 that are in communication with one another. Each cloud may be a private cloud or a public cloud. The cloud 1501 is shown to include a controller 1504, analogous to the master controllers discussed and shown herein. The cloud 1502 is shown to include a service plane 1512, similar to service planes discussed and shown herein. Alternatively, the controller 1504 resides in the cloud 1502.

The controller 1504 is shown to include a network enablement engine 1506, a service level agreement (SLA) and elasticity engine 1508, and a multi-cloud engine 1510. The network enablement engine 1506 is analogous to the network enablement engine 230 of FIG. 2. The controller 1504 may be in the same or a different cloud relative to the clouds 1502 and among other functions, defines rules. The engine 1508 receives feedback from VAS, i.e. service plane 1512. The service plane 1512 is a distributed and elastic plane, as those earlier discussed. In the embodiment of FIG. 13, the controller 1504 acts as the master while the cloud 1502 serves as slave.

The cloud 1502 is shown to include VMs 1-4, or VM 1514, VM 1516, VM 1518 and VM 1520. VMs 1518 and 1520 are each applications. The VM 1516 is an L7 ADC with application and/or zonal firewall (FW) capabilities. The VM 1514 is shown to include a L4 Application Delivery Controller (ADC) and communicates with the VM 1516 and 1520. The VMs 1520 and 1518 communicate with the VM 1516. The VM 1520 further communicates with the VM 1514.

The VMs 1516, 1518 and 1520 are each shown to include a statistic/SLA/configure agent that are in communication with the VM 1514.

Among other functions performed by the service plane 1512 in conjunction with the controller 1504 is offloading the L7 ADC VM 1516 onto the L4 ADC 1522 of the VM 1514 in times of high traffic. This clearly, optimizes the performance of the cloud 1502.

The SLA and elasticity engine 1508, at least in part, cause the service plane 1512 to be elastic. The engines 1508 and 1510 contribute to the service plane 1512 being a distributed plane.

It is understood that the configuration shown in FIG. 13 is merely a representative configuration, as are configurations shown in all figures herein. Many other configurations may be had and typically depend on usage.

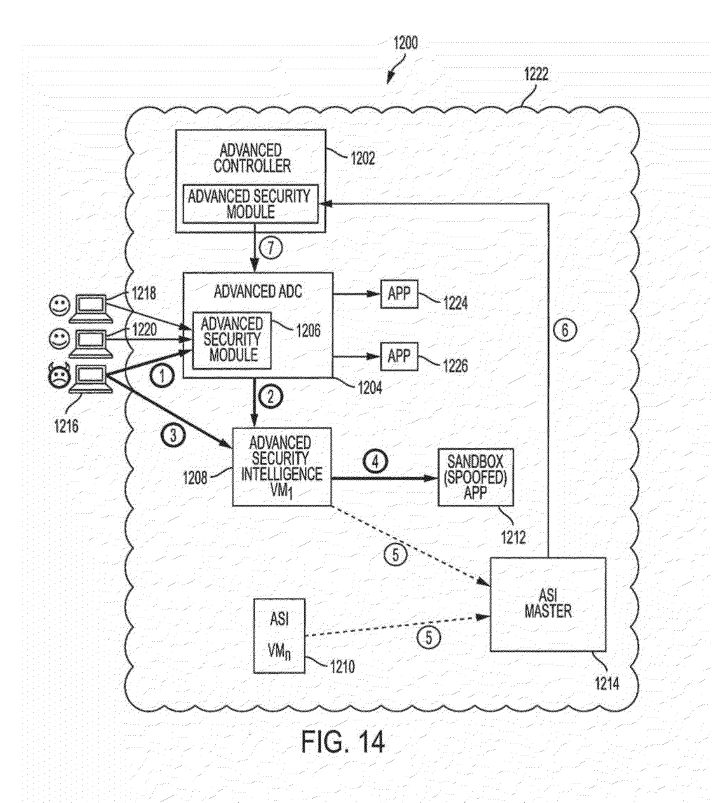

FIG. 14 shows in conceptual form, relevant portions of a multi-cloud data center 1400 with real-time cloud security, in accordance with embodiment of the invention. The multi-cloud data center 1400 has a real-time cloud security system and to this end, is shown to include an advanced controller 1402, an application delivery controller (ADC) 1404, an advanced security intelligence (ASI) virtual machine 1 (VM₁) 1408 through ASI VMn 1410, sandbox or spoofed app 1412, ASI master 1414, and applications (apps) 1424 and 1426, all of which reside in the cloud 1422. The cloud 1422 is a public, private, or hybrid cloud. While only one cloud is shown in the multi-cloud data center 1400, it is understood that the multi-cloud data center 1400 may include other clouds.

The controller 1402 and ADC 1404 are each shown to include an advanced security module (ASM) 1406. Users (or “clients” or “subscribers”) 1416, 1418, and 1420 are shown to be in communication with ASM 1406 of the ADC 1404. Client 1416 is shown as a malicious user whereas clients 1418 and 1420 are each shown to be non-malicious.

As will be further evident below, in accordance with an embodiment, the ADC 1404 receives traffic intended for a specific application from a user, the specific application being executed by a VM. The ASM 1406 of the ADC 1404 detects the received traffic as attack traffic, the received traffic being intended for routing through software defined network (SDN) switches. The controller 1402 launches virtual machines (VMs) based on the detected attack traffic. The controller 1402 also re-configures SDN switches from routing the received traffic to the VM that is executing the desired (or intended) application to re-routing the received traffic, as the attack traffic, to one or more of the launched VMs, i.e. VM₁ 1408 through VMn 1410. The attack traffic is run by the spoofed application, such as the app 1412.

Malicious users or clients attempt to discover ports or sockets that have been inadvertently left open and initiate attacks targeting a specific application such as app 1424 or app 1426 by sending an enormous number of packets to the application in an attempt to slow down the system to a point where the application can no longer provide service to any clients. For example, an application, such as a web browser, may be slowed down to a point of effectively becoming non-functional.

If the attacks are left undetected, the controller 1402 continuously tries to allocate more and more resources to the application to meet its service level agreement (SLA) requirements. In order to avoid such a situation, the attacks have to be detected at an earliest point in time to minimize the damage.

During operation, traffic typically flows through the ADC 1404 where the ASM 1406 of the ADC 1404 checks for security of the traffic and passes on the traffic to one of the ASI VMs, such as the ASI VM₁1408. The ASI VM₁ either passes the traffic to the ASI master 1414 or it passes the traffic onto the spoofed application 1412 depending on whether it detected intrusion into the traffic that is not malicious and it passes on this information to the ASM 1406 of the controller 1402. The ASI master 1414 includes a database that keeps track of and updates the security status of all traffic flowing through the ADC 1404. This information is collected by the ASM 1406 of the controller 1402 for maintaining malicious intrusion information to bypass security detection the next time the same malicious traffic arrives at the ADC 1404.

When ASM 1406 detects attack traffic from a malicious client 1416 who is targeting the apps 1424 or 1426 using tools such as deep packet inspection (DPI), pattern matching libraries, machine learning algorithm, or web application firewall rules, it routes or pushes the attack traffic to one of the ASI VM₁ 1408 through ASI VMn 1410 instead of the targeted VM. The ASI VM of the VMs 1408 through 1410 to which the attack traffic has been re-directed then routes the attack traffic to a sandbox or spoofed application 1412 and alerts the master ASI 1414 of this attack and its re-direction. Thus, cloud security is maintained in real-time.

The master ASI 1414 keeps an extensive log of attack history received from different ASI VMs 1408 through 1410. It performs analytics on the attack traffics received from ASI VMs and updates its attack signature database for future use. An attack signature is information identifying the attack traffic.

In accordance with an embodiment of the invention, the master ASI 1414 also keeps its attack signature database up-to-date using attack signatures from other third-party signature databases, such as without limitation, those made by Semantic or McAfee. Once an attack is detected, the ADC 1404 spoofs the application for which the attack was intended and limits the resources allocated to the attacked application in an attempt to slow the processing of the attack packets (“attack packets” define the “attack traffic”).

In another embodiment of the invention, the ADC 1404 blocks the attack traffic at the application level by dropping the attack packets. In yet another embodiment, the ADC blocks the attack traffic at the L2 or L3 layer by sending dynamic flow programming to software defined network (SDN) switches, which are typically a part of or in communication with a data center, such as the data center 1400 and the SDN switches manage the flow of the attack traffic on their own.

Referring still to FIG. 14, an example of the foregoing in now presented. At “1”, the malicious client 1416 sends attack packets or attack traffic to the ASM 1406 of the ADC 1404. At “2”, the ASM 1406 detects the attack packets using DPI, pattern matching libraries, machine learning algorithm, and/or web application firewall rules or any other suitable means for such detection. It also triggers the controller 1402 to launch an instance of ASI VM.

At “3”, the ASM 1406 routes the packets to one of the ASI VMs, such as the ASI VM₁ 1408. At “4”, the ASI VM₁ 1408 sends the attack packets to the spoofed app 1412 instead of the intended application. At “5”, the ASI VM₁ 1408 simultaneously or shortly before or after “4”, also sends the logs associated with the attack packets to the master ASI 1414 so that the ASI 1414 can perform analytics on the logs and update the attack signature database (in the ASI master 1414) accordingly. At “6”, the master ASI master 1414 triggers the controller 1402 to program (or configure) the SDN switches, such as the ASM 1406 of the controller 1402, to route the same attack packets intended to be sent to the ADC 1404 in the future, directly to one of the ASI VMs 1408 through 1410 as shown at “3”. Thus, traffic security is maintained by re-routing packets of a maliciously-attacked traffic to the spoofed app 1412 and performance is enhanced by bypassing the ADC 1404 when receiving future maliciously-attacked traffic.

In the case where the traffic remains unattacked, such as from the clients 1418 and 1420, data packets flow through the ADC 1404 to their intended applications, app 1424 or 1426.

In summary, in an embodiment of the invention, the ADC 1404 receives traffic intended for a specific application from a user, the specific application is executed by a VM. The ADC detects the received traffic as attack traffic, the received traffic being intended for routing through SDN switches. The controller 1402 launches VMs, such as one of VM₁ 1408 through VMn 1410, and re-configures the SDN switches from routing the received traffic to the VM of the specific application, such as the apps 1424 or 1426, to re-routing the received traffic, as the attack traffic, to the VMs it launched for spoofing the application, such as the app 1412. In this manner, the application for which the traffic is intended remains unattacked.

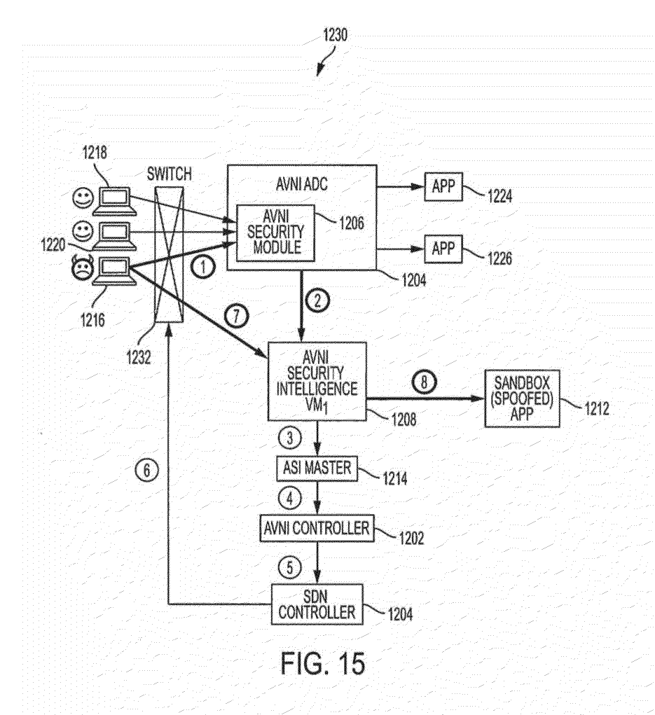

FIG. 15 shows in conceptual form, a flow diagram of traffic within a multi-cloud data center 1430 with real-time cloud security, in accordance with an exemplary method and embodiment of the invention. At “1”, the malicious client 1416 sends attack packets or attack traffic to ASM 1406 of the ADC 1404. The ASM 1406 detects the attack using DPI, as an example. At “2”, the ASM 1406 routes the attack packets to the ASI VM₁ 1408. At “3”, the ASI VM₁ 1408 also sends a log of the attack packets to the ASI master 1414 to allow the ASI master 1414 to perform and update its attack signature database.

At “4”, the ASI master 1414 triggers the controller 1402 and sends information associated with the attack thereto. At “5”, the controller 1402 communicates with the SDN controller 1424 to program (or configure) these switches for rerouting of future attack traffic and packets directly to the ASI VMs. At “6” the SDN controller 1424 sends the traffic, with attack packets, to SDN switches 1432 and the SDN switches route the attack packets to the ASI VM₁ 1408 instead of the ADC 1404 at “7”. Thus, the SDN switches 1432 routes subsequent packets initiated by the malicious user 1416 directly to the ASI VM₁ 1408. At “8”, the ASI VM₁ 1408 forwards the attack packets to the spoofed app 1412 instead of to the intended app. To the malicious user 1416, re-routing the flow of attack traffic to the spoofed app 1412 instead of the intended application remains invisible. It is as if the attack traffic flow is to the intended application.]

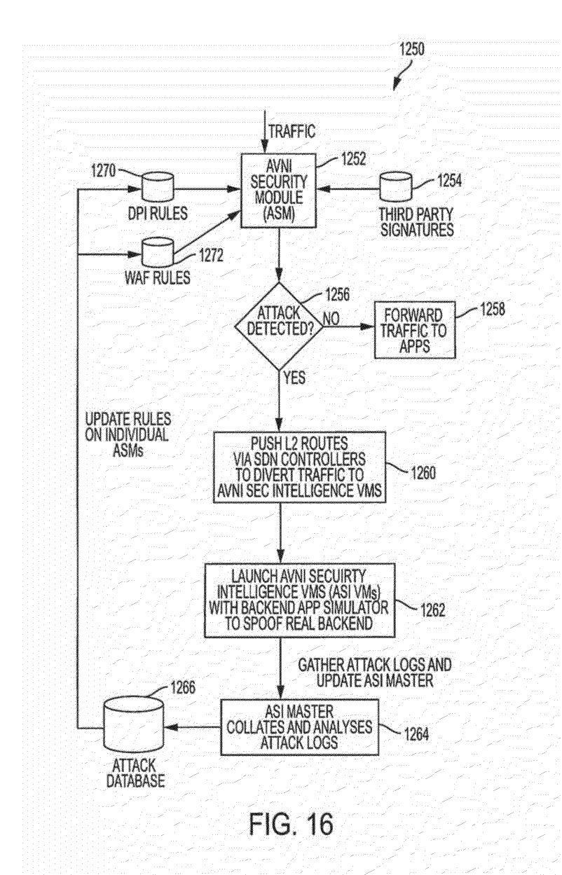

FIG. 16 shows a flow chart of some of real-time cloud security steps performed by the multi-cloud data center 1450, in accordance with a method of the invention. At step 1452, the traffic from users (or clients) is received and processed by the ASM, such as the ASM 1406 of the embodiment of FIG. 1. The ASM uses DPI, pattern matching libraries, machine learning algorithm, and web application firewall (WAF) rules or any other suitable means of security processing. The ASM is also in communication with third-party attack signature providers 1554, such as those by McAfee or Semantec, to keep its signature database current.

Next, at step 1456, a determination is made as to whether or not an attack is detected. If an attack is not detected; “N”, the process proceeds to step 1458 where the packet is forwarded to the intended application. If an attack is detected; “Y”, the process proceeds to step 1460 where the ASM diverts the traffic to an ASI VM, such as the ASI VM₁ 1408 or the ASI VMn 1410 of FIG. 1) instead of the desired application and therefore pushes L2 and routes to the SDN switch using a SDN controller and reroutes any future traffic from a compromised port accordingly.

The process proceeds to step 1462. At step 1662, the ASM triggers the controller, such as the advanced controller 1402 of FIG. 1, to launch an instance of an ASI VM with a backend application emulator or spoofed application. Next, at step 1464, the attack logs are sent by the ASI VMs to the master ASI, such as the master ASI 1414. The master ASI collates and performs analytics on the logs. At step 1466, the master ASI updates its database and adds attack signatures to its signature database and updates the rules relating to attack signatures of individual ASMs, such as the ASMs 1406 in FIG. 1, accordingly. Then, the process repeats itself.

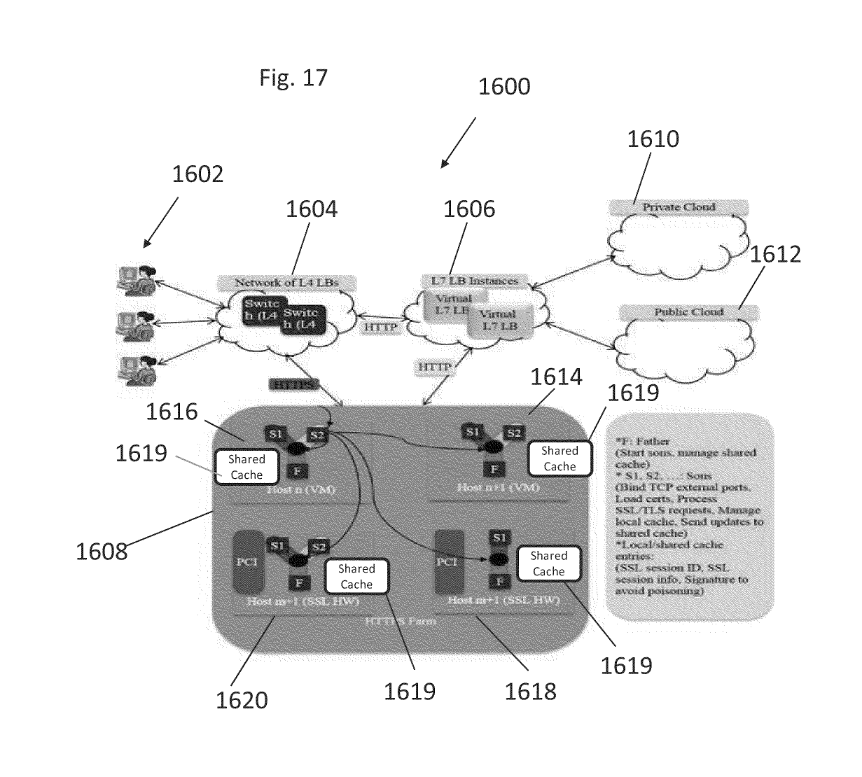

Referring now to FIG. 17, a deployment system 1600 is shown, in accordance with an embodiment of the invention. In an embodiment of the invention, SSL offloading is performed. In yet another embodiment of the invention, VMs are elastically and in real-time deployed to achieve higher scalability using the scale-out and scale-in of VMs.

A SSL farm includes VMs that are scaled in accordance with data traffic. The SSL farm includes a (father) “F” VM, which serves as the master VM to one or more (son) “S” VMs. Based on dynamically increasing or decreasing of load (traffic), the number of “S” VMs changes dynamically creating an elastic scaling of resources. This serves to increase optimization of a data center (clouds). For example, in a transaction-related application, as the number of transactions grow, the farm can grow by adding more “S” VMs.

To this end, highly scalable VMs are used across multiple machines (computing devices), as explained and shown below. L4-L7 load balancing is done to offload the SSL farms. An example of a SSL farm is the SSL servers 1608 of FIG. 17. Further, the system 1600 elastically brings up or removes the number of “S” VMs, based on traffic needs. For example if the traffic from the client 1602 is heavy, “S” VMs may be brought up (“deployed” or “launched”) by the master controller, such as the controller unit 212 of FIG. 2, and when there is less traffic, “S” VMs may be removed.

The deployment system 1600 is shown to include clients 1602 (also referred to herein as “users” or “subscribers”) who are shown to be in communication with a Layer 4 (L4) switches 1604 while they are browsing through their browsers. The switches 1604 are shown to be in communication with SLL servers 1608 and L7-L8 instances 1606. Instances 1606 are also shown to be in communication with the servers 1608 as well as with private cloud 1610 and public cloud 1612.

Communication between the switches 1604 and the servers 1608 is done through Secure Hyper Text Transfer Protocol (HTTPS), in an embodiment of the invention. Communication between the instances 1606 and the servers 1608 is done through HTTP, as is the communication between the switches 1604 and the instances 1606, in accordance with an embodiment of the invention. L4 switches are a part of a network of load balancers (L4 switch). Caches are shared across VMs. For example, if a VM does not need to do encryption/decryption, the VM directly uses the cache and need not to negotiations. If servers are running too hot, new “S”s are brought up dynamically and if lower traffic is experienced and the number of “S”s is lowered. In this manner, the system 1600 is elastic.

For existing clients, no encryption/decryption need be performed because the key is already known. Only for new clients does encryption/decryption need to be performed.

In accordance with the above, scalability is achieved without the use of dedicated hardware.

In FIG. 17, and switches 1604 and the instances 1606 may be a part of the cloud 1610 and the cloud 1612. The master controller, such as the master controller 1018 of FIG. 8, brings up the load balancer (switches 1604) and the virtual machines “S”s and the (father) “F”s, as well as the instances 1606.

The servers 1608 are shown to include four host VMs 1614-1620. Each host VM has a “father” (or “F”) VM, one or more son (or “S”) VMs and a local shared cache 1619. The F VM and the S VMs of each host VM share the local shared cache 1619 but control of the cache 1619 remains under the control of F VMs. The cache 1619 of each host VM may be accessible by other host VMs. In an embodiment of the invention, host VMs 1620 and 1618 are each shown to have SSL hardware, i.e Peripheral Component interconnect (PCI), and therefore do not need encryption/decryption (generally performed by S's), rather, encryption/decryption is performed by hardware, as is done by host VMs 1616 and 1614 running on a computing device, such as a server, which do not have respective PCIs.

The host VMs 1614-1620 intelligently share information by sharing caches. For example, if one has performed encryption and/or decryption identical to that which another must later perform, there is no need to repeat the encryption/decryption process, as this information is readily available by another host VM.

The instances 1606, which are VMs, in an embodiment of the invention, are L7 L8 and are therefore in communication with a private cloud, i.e. cloud 1610, with security, which is essentially L7 to HTTPS encryption flow.

The FVM of each host VM is essentially the master VM and controls/commands the SVMs of the host VMs to act, or not, as the case may be. Thus, S VMs of each host VM are essentially slaves. FVMs decide the number of S's to use based on load (traffic).

While four host VMs are shown included in the servers 108, it is understood that any number of host VMs may be employed. Similarly the configuration of the Fs and S's is flexible, as described above. The servers 1608 receive traffic from clients 1602, through the switches 1604 and based on the characteristics of the traffic, the servers 1608 automatically, dynamically, substantially in-real time, and seamlessly re-configure the VMs 1614-1620. Further, the servers 1608 dynamically assign processes to be performed to the VMs 1614-1620, such as encryption/decryption, based on the load, traffic, attacks and the like.

VMs grouped (in a “farm”) under HTTPS act as SSL offload machines. For example, any of the VMs 1614-1620 may act as SSL machines to offload another VM and/or remove a VM for various reasons, such as without limitation, an attack. Additionally, adding/removal of VMs from HTTPS farm, depending on the processor (or central processing unit “CPU”), such as an x86 processor, usage of the existing machines in the farm, and the number of incoming HTTPS requests, makes their deployment elastic. Accordingly, specialized hardware is not required.

The VMs 1614-1620 also share resources, such as each other's cache. It is contemplated that the VMs also share resources other than the cache.

The host VMs of the servers 1608 are advantageously dynamically and substantially in real-time re-configurable with the flexibility of taking one or more of them out of the path of traffic coming from the switches 1604 and/or instances 1606, or adding one or more depending on the load and/or client request, traffic flow, and the like. This scaling up/down of VMs, as needed, is done automatically and substantially in real-time thus making the VMs elastic, dynamic, automatic, and seamless. VMs 1614-1620 are accordingly deployed.

In an embodiment of the invention, the switches 1604 and the instances 1606 are inside each of the clouds 1610 and 1612 (replicated in each cloud).

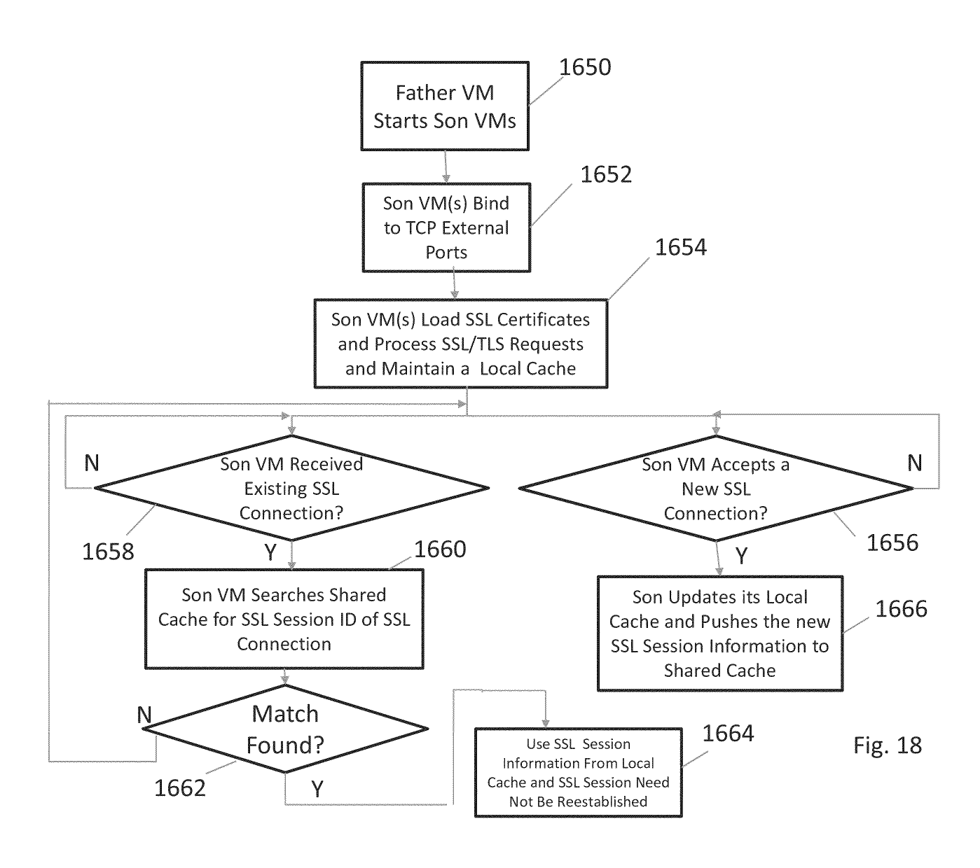

The Father/Sons model of the embodiment of FIG. 17 provides seamless SSL session migration in and across host VMs 1614-1620, an example of which is shown by the flow chart of FIG. 18.

FIG. 18 shows a flow chart of some of the steps performed by the SSL farm of FIG. 17, in accordance with an exemplary method of the invention. At step 1650, the F VM of one of the hosts 1614-1620 starts S VMs. Next, at step 1652, S VMs bind to TCP external ports. Next at step 1654, S VMs load SSL certificates and process SSL/Transport Layer Security (TLS) requests and maintain the cache 1619 of FIG. 17. The cache 1619 has SSL session IDs and other relevant SSL session information. The cache 1619 also maintains signatures to avoid cache poisoning.

While not shown, each of the S VMs may have their own local caches. At 1656, in FIG. 18, if an S VM accepts a new SSL connection, the process continues to step 1666 where the S VM updates its corresponding cache and pushes the new SSL session information to a corresponding shared cache 1619. The S VM also updates the cache 1619 the shared caches of other host VMs in the server farm. As previously noted, the Father VM manages this shared cache. When a SVM receives an existing SSL connection, detected at 1658, at step 1660, it looks up its shared cache for this existing SSL session and identifies it with the SSL Session ID. If a match is found at 1662, at step 1664, the SVM uses the SSL session information in the cache 1619. As a result, the SSL session need not be re-established, and can simply be migrated from one SVM to another SVM, either on the same VM, or across VMs.

Once a clear text HTTP is obtained from the original HTTPS data, this clean-text data is forwarded to the L7-vADC for regular processing.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A method of deployment of virtual machines (VMs) comprising:
receiving traffic having characteristics from clients;
based on the traffic, dynamically bring up son VMs and when the traffic goes down, removing son VMs; and
sharing cache between the VMs by the VMs directly accessing caches for traffic from existing clients and performing encryption/decryption for new clients.

2. The method of deployment of claim 1, wherein a master controller brings up or removes the son VMs.

3. The method of deployment of claim 1, wherein the master controller dynamically and in real-time removes and brings up son VMs.
